(19) United States
(12) Patent Application Publication
(10) Pub. No.: US 2025/0386256 A1
(43) Pub. Date: Dec. 18, 2025

(54) METHOD AND APPARATUS FOR HANDLING RADIO LINK FAILURE DURING PATH SWITCH

(71) Applicant: Telefonaktiebolaget LM Ericsson (publ), Stockholm (SE)

(72) Inventors: Zhang Zhang, Beijing (CN); Antonino Orsino, Jorvas (FI); Nithin Srinivasan, Köln (DE)

(21) Appl. No.: 18/867,484

(22) PCT Filed: Feb. 1, 2023
(86) PCT No.: PCT/CN2023/074090

§ 371 Date: Nov. 20, 2024

(30) Foreign Application Priority Data
May 20, 2022 (WO) PCT/CN2022/094201

(51) Int. Cl. H04W 36/00

(52) U.S. Cl. CPC H04W 36/0079; H04W 36/0058

(57) ABSTRACT

Embodiments of the present disclosure provide a method and an apparatus for handling radio link failure during path switch. A method performed by a terminal device comprises: receiving a command, indicating a switch for the terminal device between a first cell and a second cell, and indicating the terminal device to keep a first path with the first cell and a second path with the second cell during the switch; detecting a first radio link failure, RLF, on the first path, and/or a second RLF on the second path; and transmitting a first message indicating a first RLF over the second path, when the first RLF is detected on the first path. Accordingly, the terminal device does not abort current radio links/paths directly, and connectivity interruption may be avoided.

### TECHNICAL FIELD

The present disclosure relates generally to the technology of communication, and in particular to a method and an apparatus for handling radio link failure during path switch.

### BACKGROUND

This section introduces aspects that may facilitate better understanding of the present disclosure. Accordingly, the statements of this section are to be read in this light and are not to be understood as admissions about what is in the prior art or what is not in the prior art.

In a telecommunication network, a terminal device may access a cell served by a base station, and thus receive telecommunication service from the network itself, or other device (such as any host, any other terminal device) connected to the network.

In some scenarios, the terminal device needs to switch from one cell (i.e., a source cell) to another cell (i.e., a target cell). During such switch, a radio link failure may be experienced on either a path towards the source cell or a path toward the target cell.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

As mentioned above, a radio link failure may occur during a switch for a terminal device from one cell to another. The terminal device may trigger a radio resource control, RRC, reestablishment procedure. However, the reestablishment procedure will cause a consequent long connectivity interruption, increased power consumption and increased signaling overhead.

Certain aspects of the present disclosure and their embodiments may provide solutions to these or other challenges. There are, proposed herein, various embodiments which address one or more of the issues disclosed herein. Specific method and apparatus for handling radio link failure may be provided.

A first aspect of the present disclosure provides a method performed by a first network entity. The method comprises: receiving a command, indicating a switch of the terminal device between a first cell and a second cell, and indicating the terminal device to keep a first path with the first cell and a second path with the second cell during the switch. The method further comprises: detecting a radio link failure, RLF, on the first path, and/or on the second path. The method further comprises: transmitting a first message indicating the first RLF over the second path, when the first RLF is detected on the first path.

In exemplary embodiments of the present disclosure, the first path is a direct path, or an indirect path via a first relay device. The second path is a direct path, or an indirect path via a second relay device. The first cell is served by a first base station. The second cell is served by a second base station.

In exemplary embodiments of the present disclosure, the terminal device is a remote user equipment, UE. The first relay device is a relay UE. The second relay device is a relay UE.

In exemplary embodiments of the present disclosure, the first message comprises a first RLF report. The terminal device transmits the first RLF report when or after the switch is completed.

In exemplary embodiments of the present disclosure, the first RLF report comprises information about at least one of: whether a first path is a direct path or an indirect path; whether the first RLF happens on a PC5 link, or a Uu link, when the first path is an indirect path; after how long of receiving the command the first RLF occurred; an identifier of a first relay device for the first path, when the first path is an indirect path; an identifier of the first cell in which the first RLF has been detected; and/or a time duration the first RLF persisted, when the first path restored from the first RLF during the switch.

In exemplary embodiments of the present disclosure, the first message comprises a first indication, indicating that the first path failed.

In exemplary embodiments of the present disclosure, the first message is transmitted to the second relay device, during the switch. Or, the first message is transmitted to the second relay device over a PC5 link, when the switch is completed. Or, the first message is transmitted by the terminal device to the second base station.

In exemplary embodiments of the present disclosure, detecting the first RLF comprises: obtaining information about the first RLF from the first relay device, when the first RLF is on a Uu link of the first path; or detecting the first RLF by the terminal device itself, when the first RLF is on a PC5 link of the first path.

In exemplary embodiments of the present disclosure, the method further comprises informing the first relay device about the switch, after obtaining information about the first RLF from the first relay device, when the first RLF is on a Uu link of the first path.

In exemplary embodiments of the present disclosure, information about the first RLF is transmitted by the first relay device to the first base station, when the first relay device detects that the first RLF is on a PC5 link of the first path. The first base station informs the second base station about the switch of the terminal device.

In exemplary embodiments of the present disclosure, the first indication comprises information about at least one of: whether the first path is a direct path or an indirect path; latest measurements available at the terminal device on frequencies of the first path; a cause for the first RLF; and/or whether the first RLF happened on a PC5 link or a Uu link of the first path.

In exemplary embodiments of the present disclosure, information about the first RLF received from the terminal device is further broadcast by the second relay device; and/or information about the first RLF is further transmitted by the second relay device to the first relay device.

In exemplary embodiments of the present disclosure, the method may further comprise: transmitting to the first relay device, an indication about a start of the switch; and/or transmitting to the first relay device, an indication about a finish of the switch.

In exemplary embodiments of the present disclosure, the first relay device starts a timer, when receiving the indication about the start of the switch; and the first relay device declares the first RLF, when the timer expires before receiving the indication about the finish of the switch.

In exemplary embodiments of the present disclosure, the method further comprises: transmitting a second message indicating a second RLF over the first path, when the second RLF is detected on the second path. The second message comprises a second RLF report; and the terminal device transmits the second RLF report during the switch.

In exemplary embodiments of the present disclosure, the second RLF report comprises information about at least one of: whether the second RLF happens on a PC5 link, or a Uu link; after how long of receiving the command the second RLF occurred; an identifier of a second relay device for the second path; an identifier of the second cell in which the second RLF has been detected; and/or for how long the second RLF persisted, when the second path restored during the switch.

In exemplary embodiments of the present disclosure, the second message comprises a second indication, indicating that the second path failed.

In exemplary embodiments of the present disclosure, the second message is transmitted to the first relay device, during the switch, or the second message is transmitted to the first relay device over a PC5 link, when the switch is completed; and the first relay device forward the second indication to the first base station, or the second message is transmitted by the terminal device to the first base station.

In exemplary embodiments of the present disclosure, detecting the second RLF comprises: obtaining information about the second RLF from the second relay device, when the second RLF is on a Uu link of the second path; or detecting the second RLF by the terminal device itself, when the second RLF is on a PC5 link of the second path.

In exemplary embodiments of the present disclosure, the second indication comprises information about at least one of: latest measurements available at the terminal device on frequencies of the second path; a cause for the second RLF; and/or whether the second RLF happened on a PC5 link or a Uu link of the second path.

In exemplary embodiments of the present disclosure, the first relay device broadcasts information about the second RLF received from the terminal device; and/or the first relay device transmits information about the second RLF to the second relay device.

In exemplary embodiments of the present disclosure, the method may further comprise: transmitting to the second relay device, an indication about a start of the switch; and/or transmitting to the second relay device, an indication about a finish of the switch.

In exemplary embodiments of the present disclosure, the second relay device starts a timer, when receiving the indication about the start of the switch. The second relay device declares the second RLF, when the timer expires before receiving the indication about the finish of the switch.

In exemplary embodiments of the present disclosure, the method may further comprise: triggering a radio resource control, RRC, reestablishment procedure, when the terminal device detects the first RLF and the second RLF.

In exemplary embodiments of the present disclosure, the first RLF and/or the second RLF is detected when at least one of following happens: a physical layer problem over a Uu link or a PC5 link; a random access failure over a Uu link; a radio link control, RLC, failure over a Uu link or a PC5 link; a hybrid automatic repeat request, HARQ, failure over a Uu link or a PC5 link; a listen before talk, LBT, failure over a Uu link or a PC5 link; a beam failure recovery procedure has failed over a Uu link or a PC5 link; a reconfiguration with sync failure over a Uu link or a PC5 link; and/or an expiration of a timer that is started when the switch is started.

In exemplary embodiments of the present disclosure, the method further comprises: abandoning the switch and continuing to use the first path for transmissions and receptions, after detecting the second RLF.

In exemplary embodiments of the present disclosure, the terminal device receives a reconfiguration from the first base station, after detecting the second RLF; and the reconfiguration indicates another switch to a third cell, or indicates another second path to the second cell, or indicates a restoration of the first path.

In exemplary embodiments of the present disclosure, the reconfiguration is transmitted within a RRC message, or a downlink message over a downlink control channel, DCCH.

In exemplary embodiments of the present disclosure, the terminal device receives a RRC release message from the first base station, after detecting the first RLF and/or the second RLF.

In exemplary embodiments of the present disclosure, the command indicates a plurality of second paths for the switch, and/or a priority order for the plurality of second paths.

In exemplary embodiments of the present disclosure, the first cell is a new radio, NR, cell, or a long term evolution, LTE, cell; and/or the second cell is a NR cell, or a LTE cell.

A second aspect of the present disclosure provides a method performed by a first base station. The method comprises: transmitting a command to a terminal device. The command indicates a switch of the terminal device between a first cell and a second cell, and indicates the terminal device to keep a first path with the first cell and a second path with the second cell during the switch. The method further comprises: receiving a second message about a second RLF on the second path.

In exemplary embodiments of the present disclosure, the first path is a direct path, or an indirect path via a first relay device. The second path is a direct path, or an indirect path via a second relay device. The first cell is served by the first base station. The second cell is served by a second base station.

In exemplary embodiments of the present disclosure, the first relay device informs the first base station about a first RLF on the first path, when the first relay device detects that the first RLF is on a PC5 link of the first path. The first base station informs the second base station about the switch of the terminal device.

In exemplary embodiments of the present disclosure, the method further comprises: transmitting a reconfiguration to the terminal device, after receiving the second message. The reconfiguration indicates another switch to a third cell, or indicates another second path to the second cell, or indicates a restoration of the first path.

In exemplary embodiments of the present disclosure, the reconfiguration is transmitted within a RRC message, or a downlink message over a downlink control channel, DCCH.

In exemplary embodiments of the present disclosure, the method further comprises: transmitting a RRC release message to the terminal device, after receiving the second message, or receiving a first message about a first RLF on the first path.

In exemplary embodiments of the present disclosure, the command indicates a plurality of second paths for the switch, and/or a priority order for the plurality of second paths.

In exemplary embodiments of the present disclosure, the first cell is a new radio, NR, cell, or a long term evolution, LTE, cell. The second cell is a NR cell, or a LTE cell.

A third aspect of the present disclosure provides a method performed by a second base station. The method comprises: receiving a first message about a first RLF on a first path from a terminal device, during a switch for the terminal device between a first cell and a second cell. The terminal device keeps the first path with the first cell and a second path with the second cell during the switch.

In exemplary embodiments of the present disclosure, the first path is a direct path, or an indirect path via a first relay device. The second path is a direct path, or an indirect path via a second relay device. The first cell is served by a first base station. The second cell is served by the second base station.

In exemplary embodiments of the present disclosure, the terminal device informs the first relay device about the switch, after obtaining information about the first RLF from the first relay device, when the first RLF is on a Uu link of the first path. The first relay device informs a third base station about the switch of the terminal device, after reestablishing a connection to the third base station. The third base station informs the second base station about the switch of the terminal device. The third base station is the same as the first base station, or different with the first base station.

In exemplary embodiments of the present disclosure, the first relay device informs the first base station about the first RLF, when the first relay device detects that the first RLF is on a PC5 link of the first path. The first base station informs the second base station about the switch of the terminal device.

A fourth aspect of the present disclosure provides a method performed by a first relay device, comprising: transmitting information about a first RLF on a first path to a terminal device, during a switch of the terminal device between a first cell and a second cell. The terminal device keeps the first path with the first cell and a second path with the second cell during the switch.

In exemplary embodiments of the present disclosure, the first path is a direct path, or an indirect path via the first relay device. The second path is a direct path, or an indirect path via a second relay device. The first cell is served by a first base station. The second cell is served by a second base station.

In exemplary embodiments of the present disclosure, the terminal device informs the first relay device about the switch, after obtaining information about the first RLF from the first relay device, when the first RLF is on a Uu link of the first path. The first relay device informs a third base station about the switch of the terminal device, after reestablishing a connection to the third base station. The third base station informs the second base station about the switch of the terminal device. The third base station is the same as the first base station, or different with the first base station.

In exemplary embodiments of the present disclosure, the first relay device informs the first base station about the first RLF, when the first relay device detects that the first RLF is on a PC5 link of the first path. The first base station informs the second base station about the switch of the terminal device.

In exemplary embodiments of the present disclosure, the second relay device broadcasts information about the first RLF received from the terminal device. The second relay device transmits information about the first RLF to the first relay device.

In exemplary embodiments of the present disclosure, the method further comprises: receiving from the terminal device, an indication about a start of the switch; and/or receiving from the terminal device, an indication about a finish of the switch.

In exemplary embodiments of the present disclosure, the first relay device starts a timer, when receiving the indication about the start of the switch. The first relay device declares the first RLF, when the timer expires before receiving the indication about the finish of the switch.

In exemplary embodiments of the present disclosure, the method further comprises: receiving from the terminal device, a second message about a second RLF on the second path; transmitting to the first base station, the second message.

In exemplary embodiments of the present disclosure, the first relay device broadcasts information about the second RLF received from the terminal device. The first relay device transmits information about the second RLF to the second relay device.

A fifth aspect of the present disclosure provides a method performed by a second relay device, comprising: receiving information about a first RLF on a first path from a terminal device, during a switch of the terminal device between a first cell and a second cell. The terminal device keeps the first path with the first cell and a second path with the second cell during the switch.

In exemplary embodiments of the present disclosure, the first path is a direct path, or an indirect path via a first relay device. The second path is a direct path, or an indirect path via the second relay device. The first cell is served by a first base station. The second cell is served by a second base station.

In exemplary embodiments of the present disclosure, the method further comprises: broadcasting information about the first RLF received from the terminal device; and/or transmitting information about the first RLF to the first relay device.

In exemplary embodiments of the present disclosure, the method further comprises: transmitting information about a second RLF on the second path, to the terminal device, when the second RLF is on a Uu link of the second path.

In exemplary embodiments of the present disclosure, the method further comprises: receiving from the terminal device, an indication about a start of the switch; and/or receiving from the terminal device, an indication about a finish of the switch.

In exemplary embodiments of the present disclosure, the second relay device starts a timer, when receiving the indication about the start of the switch. The second relay device declares the second RLF, when the timer expires before receiving the indication about the finish of the switch.

In exemplary embodiments of the present disclosure, the method further comprises: transmitting to the second base station, the first message.

In exemplary embodiments of the present disclosure, the second relay device broadcasts information about the first RLF received from the terminal device; and/or the second relay device transmits information about the first RLF to the first relay device.

A sixth aspect of the present disclosure provides an apparatus for a terminal device, comprising: a processor; and a memory. The memory contains instructions executable by the processor. The apparatus for the terminal device is operative for: receiving a command, indicating a switch of the terminal device between a first cell and a second cell, and indicating the terminal device to keep a first path with the first cell and a second path with the second cell during the switch; detecting a radio link failure, RLF, on the first path, and/or on the second path; and transmitting a first message indicating the first RLF over the second path, when the first RLF is detected on the first path.

In exemplary embodiments of the present disclosure, the apparatus is further operative to perform the method according to any of above embodiments.

A seventh aspect of the present disclosure provides an apparatus for a first base station, comprising: a processor; and a memory. The memory contains instructions executable by the processor. The apparatus for the first base station is operative for: transmitting a command to a terminal device. The command indicates a switch for the terminal device between a first cell and a second cell, and indicating the terminal device to keep a first path with the first cell and a second path with the second cell during the switch. The apparatus for the first base station is further operative for: receiving a second message about a second RLF on the second path.

In exemplary embodiments of the present disclosure, the apparatus is further operative to perform the method according to any of above embodiments.

An eighth aspect of the present disclosure provides an apparatus for a second base station, comprising: a processor; and a memory. The memory contains instructions executable by the processor. The apparatus for the second base station is operative for: receiving a first message about a first RLF on a first path from a terminal device, during a switch of the terminal device between a first cell and a second cell. The terminal device keeps the first path with the first cell and a second path with the second cell during the switch.

In exemplary embodiments of the present disclosure, the apparatus is further operative to perform the method according to any of above embodiments.

A ninth aspect of the present disclosure provides an apparatus for a first relay device, comprising: a processor; and a memory. The memory contains instructions executable by the processor. The apparatus for the first base station is operative for: transmitting information about a first RLF on a first path to a terminal device, during a switch for the terminal device between a first cell and a second cell. The terminal device keeps the first path with the first cell and a second path with the second cell during the switch.

In exemplary embodiments of the present disclosure, the apparatus is further operative to perform the method according to any of above embodiments.

A tenth aspect of the present disclosure provides an apparatus for a second relay device, comprising: a processor; and a memory. The memory contains instructions executable by the processor. The apparatus for the second base station is operative for: receiving information about a first RLF on a first path from a terminal device, during a switch for the terminal device between a first cell and a second cell. The terminal device keeps the first path with the first cell and a second path with the second cell during the switch.

In exemplary embodiments of the present disclosure, the apparatus is further operative to perform the method according to any of above embodiments.

An eleventh aspect of the present disclosure provides a computer-readable storage medium storing instructions, which when executed by at least one processor, cause the at least one processor to perform the method according to any one of above embodiments.

Another aspect of the present disclosure provides a host configured to operate in a communication system to provide an over-the-top (OTT) service. The host comprises: processing circuitry configured to provide user data; and a network interface configured to initiate transmission of the user data to a network node in a cellular network for transmission to a user equipment (UE). The network node has a communication interface and processing circuitry. The processing circuitry of the network node is configured to perform any of the method performed by the first base station and/or the second base station to transmit the user data from the host to the UE.

In embodiments of the present disclosure, the processing circuitry of the host is configured to execute a host application that provides the user data; and the UE comprises processing circuitry configured to execute a client application associated with the host application to receive the transmission of user data from the host.

Another aspect of the present disclosure provides a method implemented in a host configured to operate in a communication system that further includes a network node and a user equipment (UE). The method comprises: providing user data for the UE; and initiating a transmission carrying the user data to the UE via a cellular network comprising the network node. The network node performs any of the method performed by the first base station and/or the second base station to transmit the user data from the host to the UE.

In embodiments of the present disclosure, the method further comprises, at the network node, transmitting the user data provided by the host for the UE.

In embodiments of the present disclosure, the user data is provided at the host by executing a host application that interacts with a client application executing on the UE, the client application being associated with the host application.

Another aspect of the present disclosure provides a communication system configured to provide an over-the-top service. The communication system comprises: a host comprising: processing circuitry configured to provide user data for a user equipment (UE), the user data being associated with the over-the-top service; and a network interface configured to initiate transmission of the user data toward a cellular network node for transmission to the UE. The network node has a communication interface and processing circuitry. The processing circuitry of the network node is configured to perform any of the method performed by the first base station and/or the second base station to transmit the user data from the host to the UE.

In embodiments of the present disclosure, the communication system of the previous embodiment, further comprise: the network node; and/or the user equipment.

In embodiments of the present disclosure, the processing circuitry of the host is configured to execute a host application, thereby providing the user data; and the host application is configured to interact with a client application executing on the UE, the client application being associated with the host application.

Another aspect of the present disclosure provides a host configured to operate in a communication system to provide an over-the-top (OTT) service. The host comprises: processing circuitry configured to initiate receipt of user data; and a network interface configured to receive the user data from a network node in a cellular network, the network node having a communication interface and processing circuitry. The processing circuitry of the network node is configured to perform any of the method performed by the first base station and/or the second base station to receive the user data from the UE for the host.

In embodiments of the present disclosure, the processing circuitry of the host is configured to execute a host application, thereby providing the user data; and the host application is configured to interact with a client application executing on the UE, the client application being associated with the host application.

In embodiments of the present disclosure, the initiating receipt of the user data comprises requesting the user data.

Another aspect of the present disclosure provides a method implemented by a host configured to operate in a communication system that further includes a network node and a user equipment (UE). The method comprising: at the host, initiating receipt of user data from the UE, the user data originating from a transmission which the network node has received from the UE. The network node performs any of the method performed by the first base station and/or the second base station to receive the user data from the UE for the host.

In embodiments of the present disclosure, the method of the previous embodiment, further comprising at the network node, transmitting the received user data to the host.

Another aspect of the present disclosure provides a host configured to operate in a communication system to provide an over-the-top (OTT) service. The host comprises: processing circuitry configured to provide user data; and a network interface configured to initiate transmission of the user data to a cellular network for transmission to a user equipment (UE). The UE comprises a communication interface and processing circuitry, the communication interface and processing circuitry of the UE being configured to perform any of the method performed by the terminal device, the first relay device and/or the second relay device to receive the user data from the host.

In embodiments of the present disclosure, the cellular network further includes a network node configured to communicate with the UE to transmit the user data to the UE from the host.

In embodiments of the present disclosure, the processing circuitry of the host is configured to execute a host application, thereby providing the user data; and the host application is configured to interact with a client application executing on the UE, the client application being associated with the host application.

Another aspect of the present disclosure provides a method implemented by a host operating in a communication system that further includes a network node and a user equipment (UE). The method comprising: providing user data for the UE; and initiating a transmission carrying the user data to the UE via a cellular network comprising the network node. The UE performs any of the method performed by the terminal device, the first relay device and/or the second relay device to receive the user data from the host.

In embodiments of the present disclosure, the method of the previous embodiment, further comprises: at the host, executing a host application associated with a client application executing on the UE to receive the user data from the UE.

In embodiments of the present disclosure, the method of the previous embodiment further comprises: at the host, transmitting input data to the client application executing on the UE, the input data being provided by executing the host application. The user data is provided by the client application in response to the input data from the host application.

Another aspect of the present disclosure provides a host configured to operate in a communication system to provide an over-the-top (OTT) service. The host comprises: processing circuitry configured to utilize user data; and a network interface configured to receipt of transmission of the user data to a cellular network for transmission to a user equipment (UE). The UE comprises a communication interface and processing circuitry, the communication interface and processing circuitry of the UE being configured to perform any of the method performed by the terminal device, the first relay device and/or the second relay device to transmit the user data to the host.

In embodiments of the present disclosure, the cellular network further includes a network node configured to communicate with the UE to transmit the user data from the UE to the host.

In embodiments of the present disclosure, the processing circuitry of the host is configured to execute a host application, thereby providing the user data; and the host application is configured to interact with a client application executing on the UE, the client application being associated with the host application.

Another aspect of the present disclosure provides a method implemented by a host configured to operate in a communication system that further includes a network node and a user equipment (UE). The method comprises: at the host, receiving user data transmitted to the host via the network node by the UE. The UE performs any of the method performed by the terminal device, the first relay device and/or the second relay device transmit the user data to the host.

In embodiments of the present disclosure, the method of the previous embodiment, further comprises: at the host, executing a host application associated with a client application executing on the UE to receive the user data from the UE.

In embodiments of the present disclosure, the method of the previous embodiments, further comprises: at the host, transmitting input data to the client application executing on the UE, the input data being provided by executing the host application. The user data is provided by the client application in response to the input data from the host application.

Embodiments herein afford many advantages. According to embodiments of the present disclosure, an improved manner for handling radio link failure during path switch may be provided. Particularly, when the terminal device detects any RLF during a switch, the terminal device does not abort current radio links/paths directly, namely, does not trigger any RRC reestablishment procedure directly. Instead, the terminal device notifies other device (such as relay device, base station, etc.) over the path about the RLF. The switch may be continued in some scenarios, and thus connectivity interruption, extra power consumption and signaling overhead may be avoided or at least mitigated.

### BRIEF DESCRIPTION OF DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1A is an exemplary diagram showing a multipath scenario for a terminal device to be connected to a base station.

FIG. 1B is an exemplary diagram showing a User Plane Stack for L2 UE-to-Network Relay UE.

FIG. 1C is an exemplary diagram showing a Control Plane for L2 UE-to-Network Relay UE.

FIG. 1D is an exemplary diagram showing an Intra-gNB Path Switch, Indirect-to-direct.

FIG. 1E is an exemplary diagram showing an Intra-gNB Path Switch, direct-to-indirect.

FIG. 1F is an exemplary diagram showing a procedure for Intra-AMF/UPF Handover.

FIG. 2A is a flow chart illustrating a method performed by terminal device, in accordance with some embodiments of the present disclosure.

FIG. 2B is a flow chart illustrating substeps of the method as shown in FIG. 2A.

FIG. 2C is a flow chart illustrating additional steps of the method as shown in FIG. 2A.

FIG. 2D is a flow chart illustrating substeps of the method as shown in FIG. 2A.

FIG. 2E is a flow chart illustrating additional steps of the method as shown in FIG. 2A.

FIG. 2F is a flow chart illustrating additional steps of the method as shown in FIG. 2A.

FIG. 3A is a flow chart illustrating a method performed by a first base station, in accordance with some embodiments of the present disclosure.

FIG. 3B is a flow chart illustrating additional steps of the method as shown in FIG. 3A.

FIG. 4 is a flow chart illustrating a method performed by a second base station, in accordance with some embodiments of the present disclosure.

FIG. 5A is a flow chart illustrating a method performed by a first relay device, in accordance with some embodiments of the present disclosure.

FIG. 5B is a flow chart illustrating additional steps of the method as shown in FIG. 5A.

FIG. 6A is a flow chart illustrating a method performed by a second relay device, in accordance with some embodiments of the present disclosure.

FIG. 6B is a flow chart illustrating additional steps of the method as shown in FIG. 6A.

FIG. 7A is a block diagram showing an exemplary apparatus for a terminal device, which is suitable for perform the method according to embodiments of the disclosure.

FIG. 7B is a block diagram showing an exemplary apparatus for a first base station, which is suitable for perform the method according to embodiments of the disclosure.

FIG. 7C is a block diagram showing an exemplary apparatus for a second base station, which is suitable for perform the method according to embodiments of the disclosure.

FIG. 7D is a block diagram showing an exemplary apparatus for a first relay device, which is suitable for perform the method according to embodiments of the disclosure.

FIG. 7E is a block diagram showing an exemplary apparatus for a second relay device, which is suitable for perform the method according to embodiments of the disclosure.

FIG. 8 is a block diagram showing an apparatus/computer readable storage medium, according to embodiments of the present disclosure.

FIG. 9A is a block diagram showing units of an exemplary apparatus for a terminal device, which is suitable for perform the method according to embodiments of the disclosure.

FIG. 9B is a block diagram showing units of an exemplary apparatus for a first base station, which is suitable for perform the method according to embodiments of the disclosure.

FIG. 9C is a block diagram showing units of an exemplary apparatus for a base station, which is suitable for perform the method according to embodiments of the disclosure.

FIG. 9D is a block diagram showing units of an exemplary apparatus for a first relay device, which is suitable for perform the method according to embodiments of the disclosure.

FIG. 9E is a block diagram showing units of an exemplary apparatus for a second relay device, which is suitable for perform the method according to embodiments of the disclosure.

FIG. 10 shows an example of a communication system 1000 in accordance with some embodiments.

FIG. 11 shows a UE 1100 in accordance with some embodiments.

FIG. 12 shows a network node 1200 in accordance with some embodiments.

FIG. 13 is a block diagram of a host 1300, which may be an embodiment of the host 1016 of FIG. 10, in accordance with various aspects described herein.

FIG. 14 is a block diagram illustrating a virtualization environment 1400 in which functions implemented by some embodiments may be virtualized.

FIG. 15 shows a communication diagram of a host 1502 communicating via a network node 1504 with a UE 1506 over a partially wireless connection in accordance with some embodiments.

FIG. 16 is an exemplary diagram showing a path switch from an indirect to and indirect path in inter-gNBs scenarios.

FIG. 17 is an exemplary diagram showing a path switch from an indirect to a direct path in inter-gNBs scenarios.

FIG. 18 is an exemplary diagram showing a path switch from a direct to an indirect path in inter-gNBs scenarios.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the term “network” or “communication network” refers to a network following any suitable communication standards (such for an internet network, or any wireless network). For example, wireless communication standards may comprise new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. In the following description, the terms “network” and “system” can be used interchangeably. Furthermore, the communications between two devices in the network may be performed according to any suitable communication protocols, including, but not limited to, the wireless communication protocols as defined by a standard organization such as 3rd generation partnership project (3GPP) or the wired communication protocols.

The term “network entity” used herein refers to a network device or network node or network function or any other devices (physical or virtual) in a communication network. For example, the network entity in the network may include a base station (BS), an access point (AP), a multi-cell/multicast coordination entity (MCE), a server node/function (such as a service capability server/application server, SCS/AS, group communication service application server, GCS AS, application function, AF), an exposure node/function (such as a service capability exposure function, SCEF, network exposure function, NEF), a unified data management, UDM, a home subscriber server, HSS, a session management function, SMF, an access and mobility management function, AMF, a mobility management entity, MME, a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network entity may comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like.

Further, the term “network node”, “network function”, “network entity” herein may also refer to any suitable node, function, entity which can be implemented (physically or virtually) in a communication network. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), etc. In other embodiments, the network function may comprise different types of NFs (such as PCRF (Policy and Charging Rules Function), etc.) for example depending on the specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and (or) B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

In current telecommunication network, a switch for a terminal device from one cell to another cell may happen. Particularly, in a sidelink communication, one terminal device may directly communicate with another terminal device. Switch may be caused due to movement of these terminal devices (such as vehicle).

3GPP specified the LTE (Long Term Evolution) D2D (device-to-device) technology, also known as sidelink (SL) or the PC5 interface as part of Release 12 (Rel-12). The target use cases (UC) were the Proximity Services (communication and discovery). Support for such services was enhanced in Rel-13 and in Rel-14, the LTE sidelink was extensively redesigned to support vehicular communications (commonly referred to as V2X (vehicle to everything) or V2V (vehicle to vehicle)). Further enhancements were made in Rel-15, from the point of view of the lower radio layers. LTE SL uses broadcast communication i.e., transmission from a UE targets any receiver that is in range.

In Rel-16, 3GPP introduced the sidelink for the 5G new radio (NR). The driving use-case being vehicular communications with more stringent requirements than those that typically could be served by LTE SL. To meet these stringent requirements, NR SL can perform broadcast, groupcast, and unicast communications. In groupcast communication, the intended receivers of a message are typically a subset of the vehicles near the transmitter, whereas in unicast communication, there is a single intended receiver.

Both the LTE SL and the NR SL can operate with and without network coverage and with varying degrees of interaction between the UEs (user equipment) and the NW (network), including support for standalone, network-less operation.

In 3GPP Rel. 17, public safety was one of the most important use cases, which can benefit from the already developed NR sidelink features in Rel.16. Therefore, 3GPP specified enhancements related to public safety use cases taking the NR Rel 16 sidelink as the baseline. Besides, in some scenarios public safety services need to operate with partial or with or without NW (network) coverage, such as during indoor firefighting, forest firefighting, earthquake rescue, sea rescue, etc., where the infrastructure is (partially) destroyed or not available, therefore, coverage extension is a crucial enabler for public safety, for both services communicated between UE and cellular NW and that communicated between UEs over sidelink. In Rel.17, a SID (Study Item Description) on NR sidelink relay (RP-193253) was introduced which aims to further explore coverage extension for sidelink-based communication, including both UE to NW relay for cellular coverage extension and UE to UE relay for sidelink coverage extension. Now the work has proceeded to normative phase and in the WID (work item description) only UE to NW relay is considered. In addition to public safety use-cases, the NR sidelink relay WI (work item) is also designed to support other commercial use-cases which would also greatly benefit from the coverage extension. Two solutions for UE to NW relaying were specified namely Layer-2 (L2) UE-to-NW relaying and Layer-3 (L3) UE-to-NW relaying.

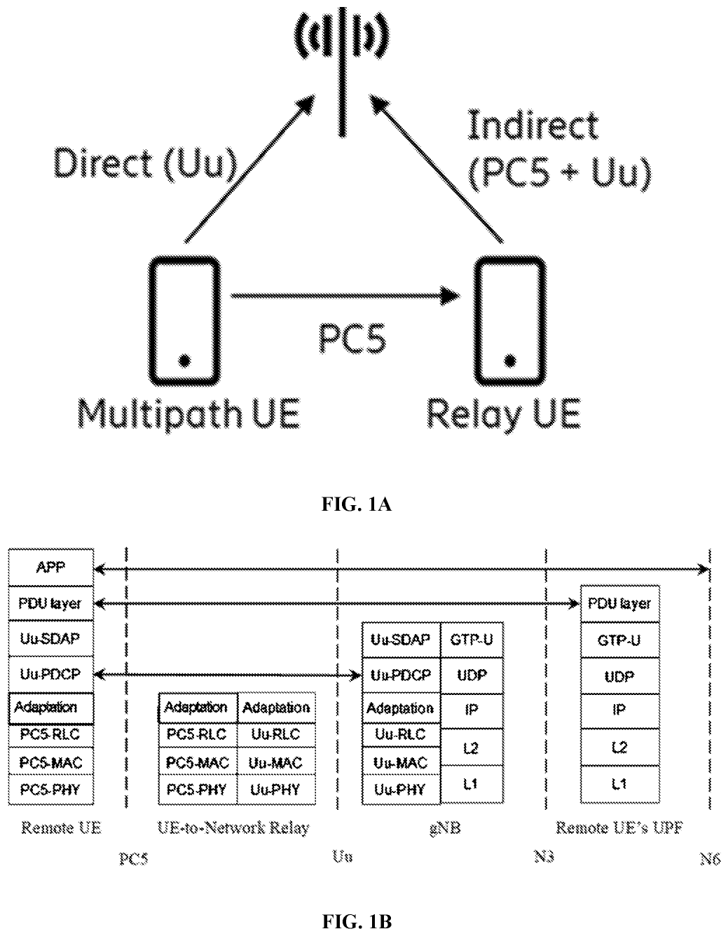

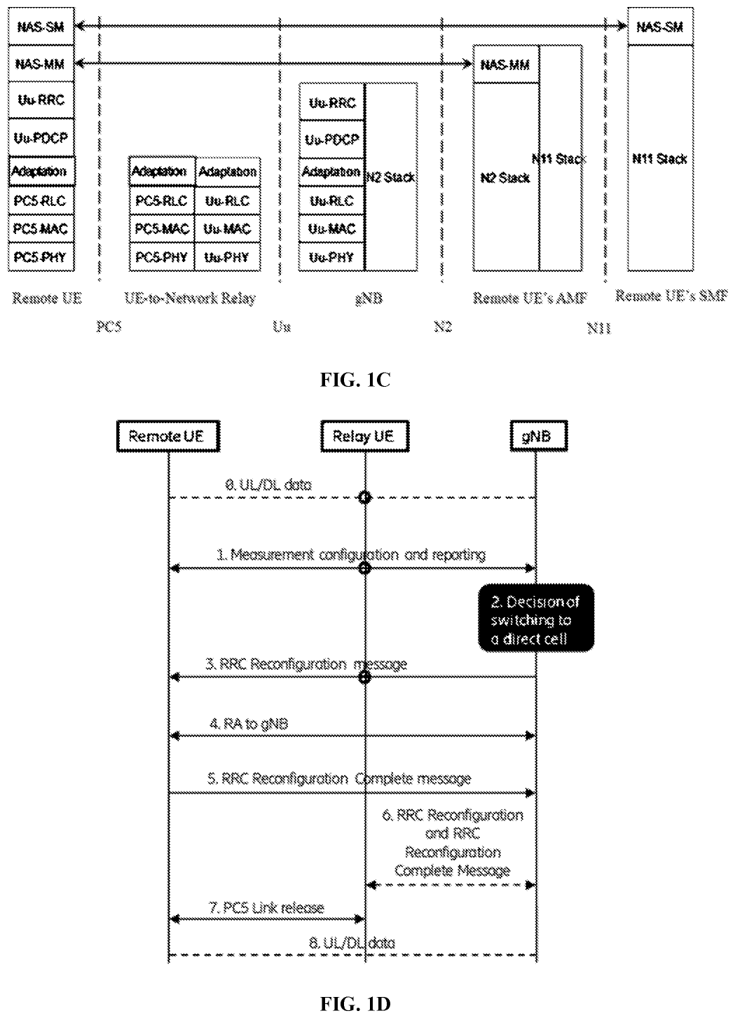

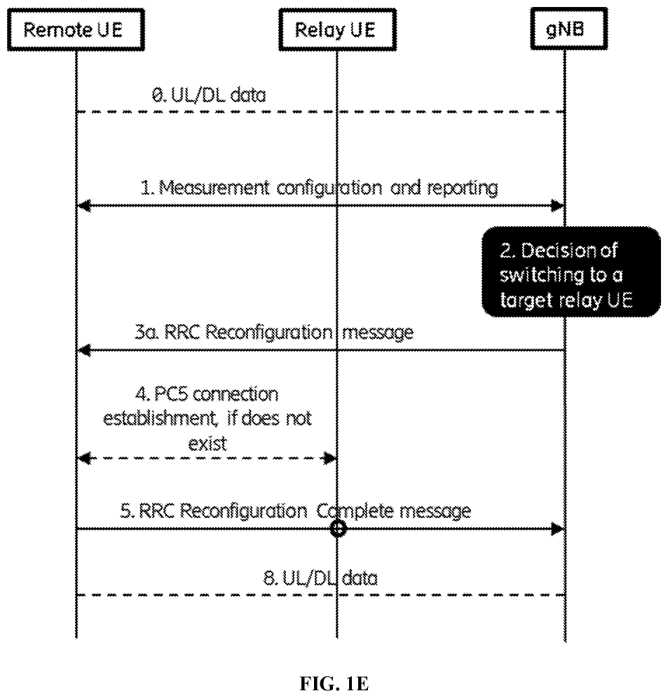

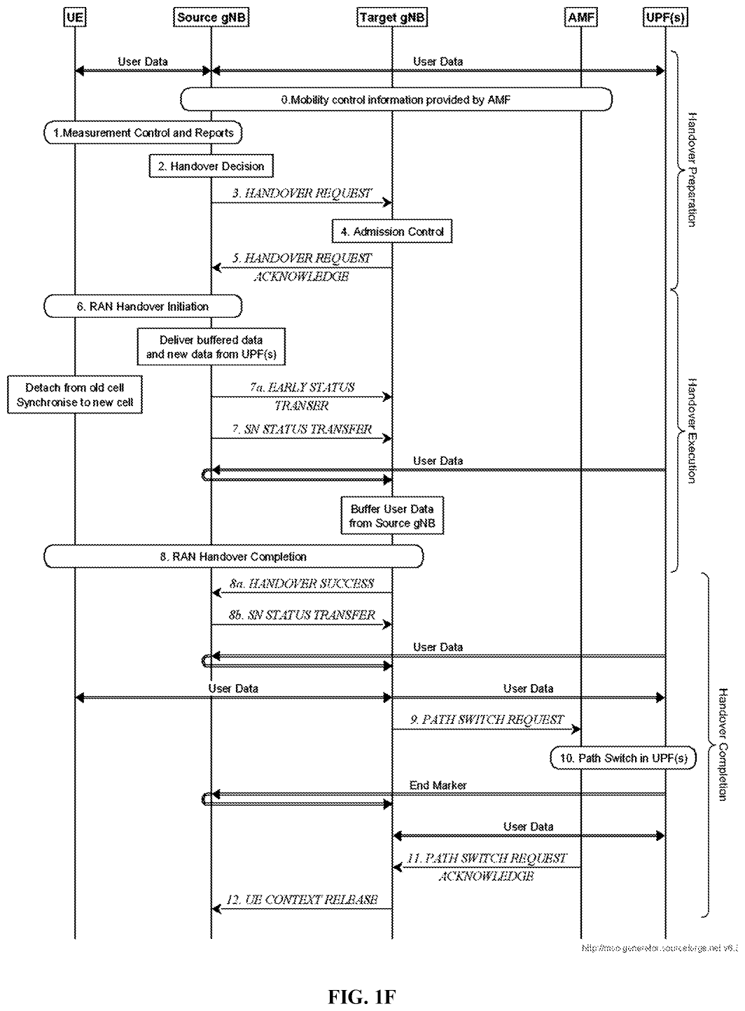

FIG. 1A is an exemplary diagram showing a multipath scenario for a terminal device to be connected to a base station.

In 3GPP RAN plenary, discussions were initiated in RAN #94 to identify the detailed motivations and work areas for the evolution of NR SL and NR SL relays in Rel-18. For NR SL relays, support for a multi-path operation with relays was agreed for its potential to improve the reliability/robustness as well as throughput. In a multi-path operation with relays, a UE is connected to the network via both a direct (UE←→Network (gNB+CN)) path and over an indirect path (UE←→Relay UE←→Network (gNB+CN)). In the direct path, the UE communicates with the gNB over a Uu interface. In the indirect path, the UE communicates with the relay UE over the sidelink PC5 interface and the relay UE communicates with the gNB over the Uu interface i.e., the UE communicates with the gNB indirectly via the PC5 and Uu interface over a single hop. The multi-path operation offers the UE a choice to perform transmission either over the direct path or over the indirect path or over both the direct and indirect path allowing for transmission flexibility.

In TR 23.752 [V17.0.0], the layer-2 (L2) based UE-to-Network (U2N) relay is described.

FIG. 1B is an exemplary diagram showing a User Plane Stack for L2 UE-to-Network Relay UE.

FIG. 1B illustrates the protocol stack for the user plane transport, related to a PDU Session, including a Layer 2 UE-to-Network Relay UE. The PDU layer corresponds to the PDU carried between the Remote UE and the Data Network (DN) over the PDU session. The PDU layer corresponds to the PDU carried between the Remote UE and the Data Network (DN) over the PDU session. It is important to note that the two endpoints of the PDCP (Packet Data Convergence Protocol) link are the Remote UE and the gNB. The relay function is performed below PDCP. This means that data security is ensured between the Remote UE and the gNB without exposing raw data at the UE-to-Network Relay UE.

The adaptation layer within the UE-to-Network Relay UE can differentiate between signaling radio bearers (SRBs) and data radio bearers (DRBs) for a particular Remote UE. The adaption relay layer is also responsible for mapping PC5 traffic to one or more DRBs of the Uu.

FIG. 1C illustrates the protocol stack of the NAS connection for the Remote UE to the NAS-MM (non access stratum mobility management) and NAS-SM (session management) components. The NAS messages are transparently transferred between the Remote UE and 5G-AN over the Layer 2 UE-to-Network Relay UE. The role of the UE-to-Network Relay UE is to relay the PDUs from the signaling radio bearer without any modifications.

As to path switch procedure, only intra-gNB path switching between indirect path and direct path is supported in Rel.17.

FIG. 1D shows the intra-gNB path switching procedure from indirect path to direct path. The procedure may comprise following steps:
Step 1: Measurement configuration and reporting;
Step 2: Decision of switching to a direct path by gNB;
Step 3: RRC Reconfiguration message to Remote UE;
Step 4: Remote UE performs Random Access to the gNB;
Step 5: Remote UE feedback the RRCReconfigurationComplete to gNB via target path, using the target configuration provided in the RRC Reconfiguration message;
Step 6: RRC Reconfiguration to Relay UE;
Step 7: The PC5 link is released between Remote UE and the Relay UE, if needed;
Step 8: The data path switching.

NOTE: The order of step 6/7/8 is not restricted. Following are further discussed in WI phase, including:
Whether Remote UE suspends data transmission via relay link after step 3;
Whether Step 6 can be before or after step 3 and its necessity;
Whether Step 7 can be after step 3 or step 5, and its necessity/replaced by PC5 reconfiguration;
Whether Step 8 can be after step 5.

FIG. 1E is an exemplary diagram showing an Intra-gNB Path Switch, direct-to-indirect.

FIG. 1E shows the intra-gNB path switching procedure from direct path to indirect path. The procedure may comprise:
Step 1: Remote UE reports one or multiple candidate Relay UE(s), after Remote UE measures/discoveries the candidate Relay UE(s).
   Remote UE may filter the appropriate Relay UE(s) meeting higher layer criteria when reporting, in step 1.
   The reporting may include the Relay UE's ID and SL RSRP information, where the measurement on PC5 details can be left to WI phase, in step 1.
Step 2: Decision of switching to a target Relay UE by gNB, and target (re)configuration is sent to Relay UE optionally (like preparation).
Step 3: RRC Reconfiguration message to Remote UE. Following information may be included: 1) Identity of the target Relay UE; 2) Target Uu and PC5 configuration.
Step 4: Remote UE establishes PC5 connection with target Relay UE, if the connection has not been setup yet.
Step 5: Remote UE feedback the RRCReconfigurationComplete to gNB via target path, using the target configuration provided in RRCReconfiguration.
Step 6: The data path switching.

NOTE: Following are further discussed in WI phase, including:
Whether Step 2 should be after Relay UE connects to the gNB (e.g. after step 4), if not yet before;
Whether Step 4 can be before step 2/3.

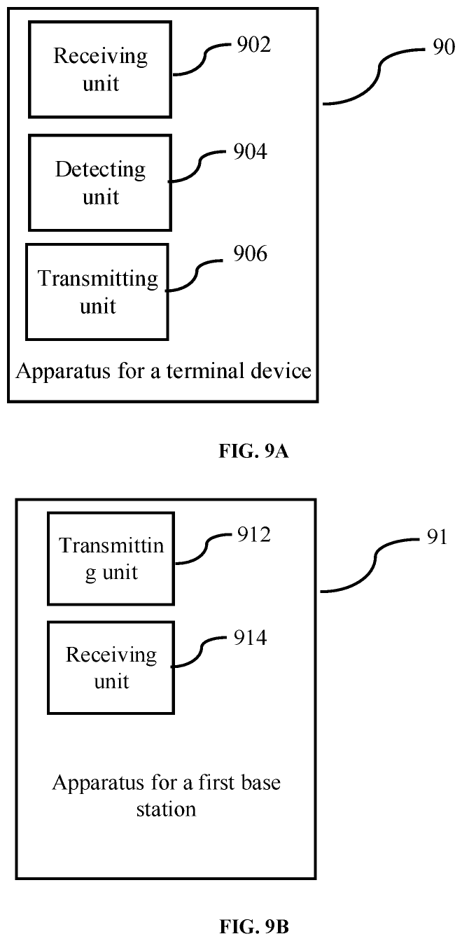

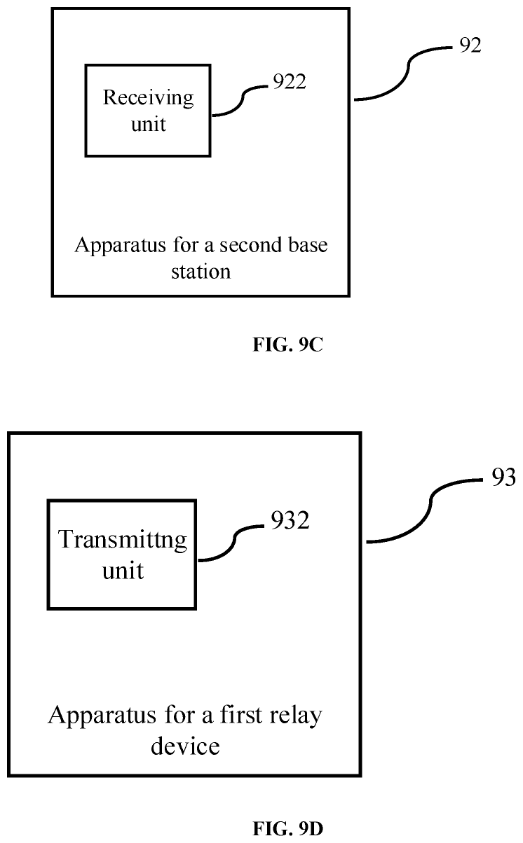

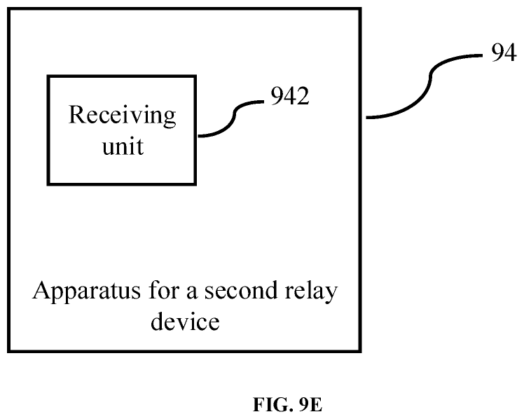

FIG. 1F is an exemplary diagram showing a procedure for Intra-AMF/UPF Handover. FIG. 1F is the same as FIG. 9.2.3.2.1-1 in 3GPP TS 38.300 V17.0.0.

3GPP TS 38.300 V17.0.0 further defines as follows about the handover procedure.

The intra-NR RAN handover performs the preparation and execution phase of the handover procedure performed without involvement of the 5GC, i.e. preparation messages are directly exchanged between the gNBs. The release of the resources at the source gNB during the handover completion phase is triggered by the target gNB. The figure below depicts the basic handover scenario where neither the AMF nor the UPF changes:

0. The UE context within the source gNB contains information regarding roaming and access restrictions which were provided either at connection establishment or at the last TA (Timing Advance) update.

1. The source gNB configures the UE measurement procedures and the UE reports according to the measurement configuration.

2. The source gNB decides to handover the UE, based on MeasurementReport and RRM information.

3. The source gNB issues a Handover Request message to the target gNB passing a transparent RRC container with necessary information to prepare the handover at the target side. The information includes at least the target cell ID, KgNB*, the C-RNTI of the UE in the source gNB, RRM-configuration including UE inactive time, basic AS-configuration including antenna Info and DL Carrier Frequency, the current QoS flow to DRB mapping rules applied to the UE, the SIB1 from source gNB, the UE capabilities for different RATs, PDU session related information, and can include the UE reported measurement information including beam-related information if available. The PDU session related information includes the slice information and QoS flow level QoS profile(s). The source gNB may also request a DAPS handover for one or more DRBs.

NOTE 1: After issuing a Handover Request, the source gNB should not reconfigure the UE, including performing Reflective QoS flow to DRB mapping.

4. Admission Control may be performed by the target gNB. Slice-aware admission control shall be performed if the slice information is sent to the target gNB. If the PDU sessions are associated with non-supported slices the target gNB shall reject such PDU Sessions.

5. The target gNB prepares the handover with L1/L2 and sends the HANDOVER REQUEST ACKNOWLEDGE to the source gNB, which includes a transparent container to be sent to the UE as an RRC message to perform the handover. The target gNB also indicates if a DAPS handover is accepted.

NOTE 2: As soon as the source gNB receives the HANDOVER REQUEST ACKNOWLEDGE, or as soon as the transmission of the handover command is initiated in the downlink, data forwarding may be initiated.

NOTE 3: For DRBs configured with DAPS, downlink PDCP SDUs are forwarded with SN assigned by the source gNB, until SN assignment is handed over to the target gNB in step 8b, for which the normal data forwarding follows as defined in 9.2.3.2.3.

6. The source gNB triggers the Uu handover by sending an RRCReconfiguration message to the UE, containing the information required to access the target cell: at least the target cell ID, the new C-RNTI, the target gNB security algorithm identifiers for the selected security algorithms. It can also include a set of dedicated RACH resources, the association between RACH resources and SSB(s), the association between RACH resources and UE-specific CSI-RS configuration(s), common RACH resources, and system information of the target cell, etc.

NOTE 4: For DRBs configured with DAPS, the source gNB does not stop transmitting downlink packets until it receives the HANDOVER SUCCESS message from the target gNB in step 8a.

NOTE 4a: CHO cannot be configured simultaneously with DAPS handover.

7a. For DRBs configured with DAPS, the source gNB sends the EARLY STATUS TRANSFER message. The DL COUNT value conveyed in the EARLYSTATUS TRANSFER message indicates PDCP SN and HFN of the first PDCP SDU that the source gNB forwards to the target gNB. The source gNB does not stop assigning SNs to downlink PDCP SDUs until it sends the SN STATUS TRANSFER message to the target gNB in step 8b.

7. For DRBs not configured with DAPS, the source gNB sends the SN STATUS TRANSFER message to the target gNB to convey the uplink PDCP SN receiver status and the downlink PDCP SN transmitter status of DRBs for which PDCP status preservation applies (i.e. for RLC AM). The uplink PDCP SN receiver status includes at least the PDCP SN of the first missing UL PDCP SDU and may include a bit map of the receive status of the out of sequence UL PDCP SDUs that the UE needs to retransmit in the target cell, if any. The downlink PDCP SN transmitter status indicates the next PDCP SN that the target gNB shall assign to new PDCP SDUs, not having a PDCP SN yet.

NOTE 5: In case of DAPS handover, the uplink PDCP SN receiver status and the downlink PDCP SN transmitter status for a DRB with RLC-AM and not configured with DAPS may be transferred by the SN STATUS TRANSFER message in step 8b instead of step 7.

NOTE 6: For DRBs configured with DAPS, the source gNB may additionally send the EARLY STATUS TRANSFER message(s) between step 7 and step 8b, to inform discarding of already forwarded PDCP SDUs. The target gNB does not transmit forwarded downlink PDCP SDUs to the UE, whose COUNT is less than the conveyed DL COUNT value and discards them if transmission has not been attempted already.

8. The UE synchronises to the target cell and completes the RRC handover procedure by sending RRCReconfigurationComplete message to target gNB. In case of DAPS handover, the UE does not detach from the source cell upon receiving the RRCReconfiguration message. The UE releases the source resources and configurations and stops DL/UL reception/transmission with the source upon receiving an explicit release from the target node.

NOTE 6a: From RAN point of view, the DAPS handover is considered to only be completed after the UE has released the source cell as explicitly requested from the target node. RRC suspend, a subsequent handover or inter-RAT handover cannot be initiated until the source cell has been released.

8a/b In case of DAPS handover, the target gNB sends the HANDOVER SUCCESS message to the source gNB to inform that the UE has successfully accessed the target cell. In return, the source gNB sends the SN STATUS TRANSFER message for DRBs configured with DAPS for which the description in step 7 applies, and the normal data forwarding follows as defined in 9.2.3.2.3.

NOTE 7: The uplink PDCP SN receiver status and the downlink PDCP SN transmitter status are also conveyed for DRBs with RLC-UM in the SN STATUS TRANSFER message in step 8b, if configured with DAPS.

NOTE 8: For DRBs configured with DAPS, the source gNB does not stop delivering uplink QoS flows to the UPF until it sends the SN STATUS TRANSFER message in step 8b. The target gNB does not forward QoS flows of the uplink PDCP SDUs successfully received in-sequence to the UPF until it receives the SN STATUS TRANSFER message, in which UL HFN and the first missing SN in the uplink PDCP SN receiver status indicates the start of uplink PDCP SDUs to be delivered to the UPF. The target gNB does not deliver any uplink PDCP SDUs which has an UL COUNT lower than the provided.

NOTE 9: Void.

9. The target gNB sends a PA TH SWITCH REQUEST message to AMF to trigger 5GC to switch the DL data path towards the target gNB and to establish an NG-C interface instance towards the target gNB.

10. 5GC switches the DL data path towards the target gNB. The UPF sends one or more “end marker” packets on the old path to the source gNB per PDU session/tunnel and then can release any U-plane/TNL resources towards the source gNB.

11. The AMF confirms the PATH SWITCH REQUEST message with the PATH SWITCH REQUEST ACKNOWLEDGE message.

12. Upon reception of the PATH SWITCH REQUEST ACKNOWLEDGE message from the AMF, the target gNB sends the UE CONTEXT RELEASE to inform the source gNB about the success of the handover. The source gNB can then release radio and C-plane related resources associated to the UE context. Any ongoing data forwarding may continue.

. . .

Upon receiving a handover command requesting DAPS handover, the UE suspends source cell SRBs, stops sending and receiving any RRC control plane signalling toward the source cell, and establishes SRBs for the target cell. The UE releases the source cell SRBs configuration upon receiving source cell release indication from the target cell after successful DAPS handover execution. When DAPS handover to the target cell fails and if the source cell link is available, then the UE reverts back to the source cell configuration and resumes source cell SRBs for control plane signalling transmission.

One of the objectives of the SL relay WI for Rel-18 is to provide service continuity during path switch in case of a scenario where a remote UE migrates from one gNB to another (this includes the case where the remote UE change the relay UE or just the direct Uu path).

According to this, when the remote UE changes gNB this means that the remote UE needs to perform random access and thus service continuity cannot guarantee since from the moment in which the remote UE leave the source gNB and the moment in which the remote UE connects to the target gNB several milliseconds/seconds may pass. One solution to provide service continuity is to use the Dual Active Protocol Stack (DAPS) that basically allow the UE to be connected to the source gNB and target gNB at the same time for the time on which the all the handover procedure is executed (and completed).

However, one issue with using DAPS in SL relay scenario is radio link failure may be experienced on 4 possible links (1 links between remote UE and source relay UE, 1 link between source relay UE and source gNB, 1 link between remote UE and target relay UE, and 1 link between target relay UE and target gNB). Given this, at the moment there is no procedure that described how the remote UE, the source/target relay UE, and the source/target gNB should behave and thus when a radio link failure is experienced during DAPS this means that the remote UE will always trigger the RRC reestablishment procedure with a consequent long connectivity interruption, increased power consumption and increased signaling overhead.

The methods and solutions described in the following exemplary embodiments describe what are the actions that the remote UE, the source/target relay UE, and the source/target gNB should perform when a radio link failure is experienced during path switch while the remote UE is configured to keep both the source and target path at the same time. This will help to minimize the connectivity interruption and avoid the path switch procedure to fail. In order to do so, at least one (or a combination) of the following solutions can be used.

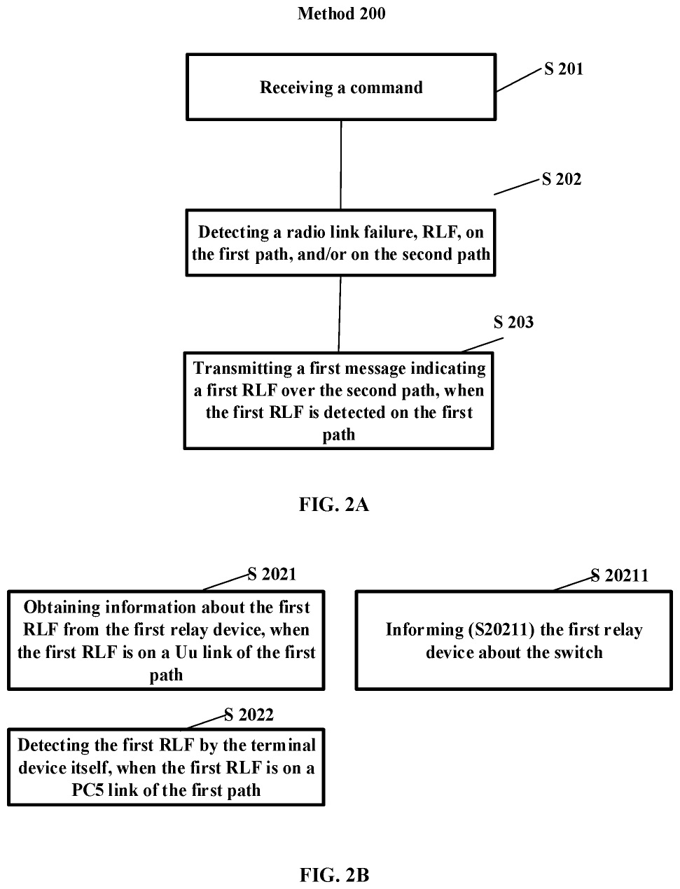

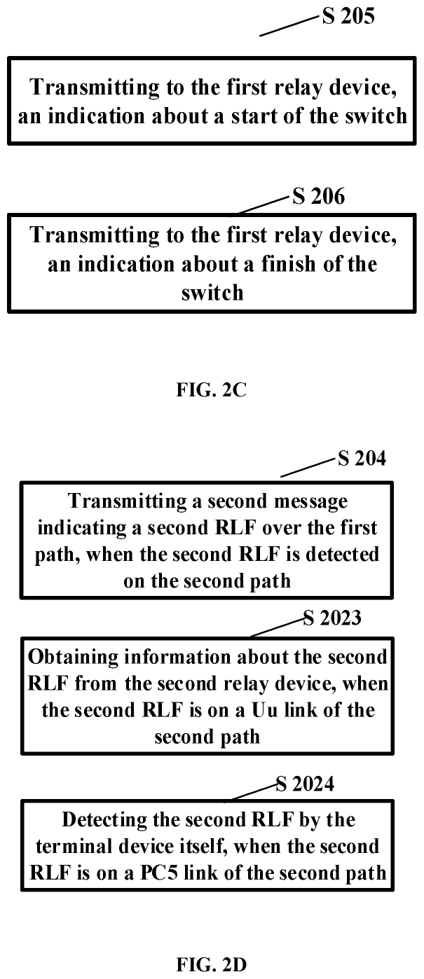

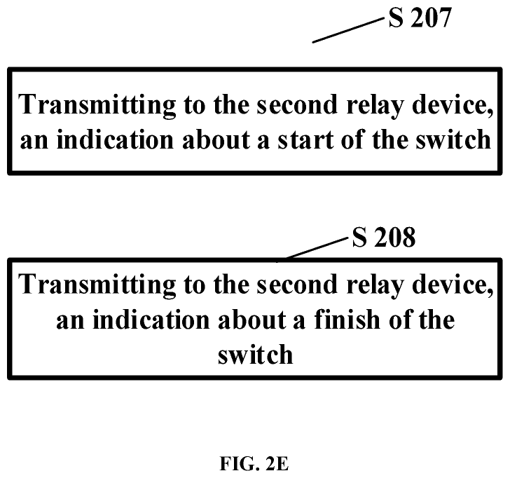

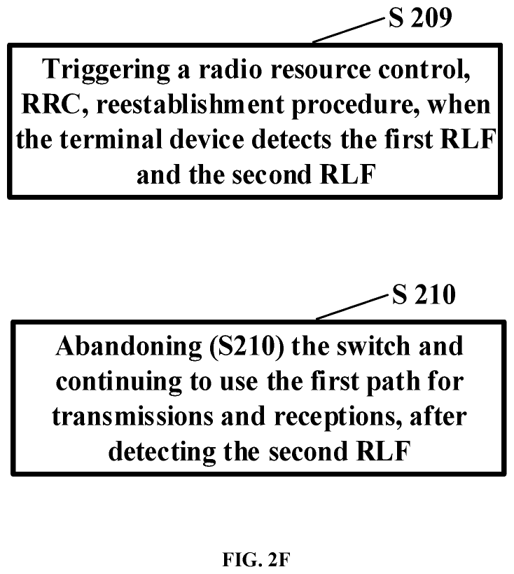

FIG. 2A is a flow chart illustrating a method performed by terminal device, in accordance with some embodiments of the present disclosure.

As shown in FIG. 2A, a first aspect of the present disclosure provides a method 200 performed by a first network entity. The method 200 comprises: a step S201, receiving a command, indicating a switch of the terminal device between a first cell and a second cell, and indicating the terminal device to keep a first path with the first cell and a second path with the second cell during the switch. The method 200 further comprises: a step S202, detecting a radio link failure, RLF, on the first path, and/or on the second path. The method 200 further comprises: a step S203, transmitting a first message indicating the first RLF over the second path, when the first RLF is detected on the first path. For example, the switch may be from the first cell to the second cell. Then, the first cell will be the source cell and the second cell will be the target cell.

According to embodiments of the present disclosure, an improved manner for handling radio link failure during path switch may be provided. Particularly, when the terminal device detects any RLF during a switch, the terminal device does not abort current radio links/paths directly, namely, does not trigger any RRC reestablishment procedure directly. Instead, the terminal device notifies other device (such as relay device, base station, etc.) over the path about the RLF.

In exemplary embodiments of the present disclosure, the first path is a direct path, or an indirect path via a first relay device. The second path is a direct path, or an indirect path via a second relay device. The first cell is served by a first base station. The second cell is served by a second base station.

In exemplary embodiments of the present disclosure, the terminal device is a remote user equipment, UE. The first relay device is a relay UE. The second relay device is a relay UE.

In exemplary embodiments of the present disclosure, the first message comprises a first RLF report. The terminal device transmits the first RLF report when or after the switch is completed.

In exemplary embodiments of the present disclosure, the first RLF report comprises information about at least one of: whether a first path is a direct path or an indirect path; whether the first RLF happens on a PC5 link, or a Uu link, when the first path is an indirect path; after how long of receiving the command the first RLF occurred; an identifier of a first relay device for the first path, when the first path is an indirect path; an identifier of the first cell in which the first RLF has been detected; and/or for how long (i.e., a time duration) the first RLF persisted, when the first path restored from the first RLF during the switch.

In exemplary embodiments of the present disclosure, the first message comprises a first indication, indicating that the first path failed.

In exemplary embodiments of the present disclosure, the first message is transmitted to the second relay device, during the switch. Or, the first message is transmitted to the second relay device over a PC5 link, when the switch is completed. Or, the first message is transmitted by the terminal device to the second base station.

FIG. 2B is a flow chart illustrating substeps of the method as shown in FIG. 2A.

In exemplary embodiments of the present disclosure, detecting (S202) the first RLF comprises: a substep S2021, obtaining information about the first RLF from the first relay device, when the first RLF is on a Uu link of the first path; or a substep S2022, detecting the first RLF by the terminal device itself, when the first RLF is on a PC5 link of the first path.

In exemplary embodiments of the present disclosure, the method further comprises: a step S20211, informing the first relay device about the switch, after obtaining information about the first RLF from the first relay device, when the first RLF is on a Uu link of the first path. The first relay device informs a third base station about the switch of the terminal device, after reestablishing a connection to the third base station. The third base station informs the second base station about the switch of the terminal device. The third base station is the same as the first base station, or different with the first base station.

In exemplary embodiments of the present disclosure, the first relay device informs the first base station about the first RLF, when the first relay device detects that the first RLF is on a PC5 link of the first path. The first base station informs the second base station about the switch of the terminal device.

In exemplary embodiments of the present disclosure, the first indication comprises information about at least one of: whether the first path is a direct path or an indirect path; latest measurements available at the terminal device on frequencies of the first path; a cause for the first RLF; and/or whether the first RLF happened on a PC5 link or a Uu link of the first path.

In exemplary embodiments of the present disclosure, the second relay device broadcasts information about the first RLF received from the terminal device; and/or the second relay device transmits information about the first RLF to the first relay device.

FIG. 2C is a flow chart illustrating additional steps of the method as shown in FIG. 2A.

In exemplary embodiments of the present disclosure, the method 200 may further comprise: a step S205, transmitting to the first relay device, an indication about a start of the switch; and/or a step S206, transmitting to the first relay device, an indication about a finish of the switch.

In exemplary embodiments of the present disclosure, the first relay device starts a timer, when receiving the indication about the start of the switch; and the first relay device declares the first RLF, when the timer expires before receiving the indication about the finish of the switch. The first relay device may declare the first RLF to terminal device, or base station, or other relay device, by dedicated message or by broadcasting.

FIG. 2D is a flow chart illustrating substeps of the method as shown in FIG. 2A.

In exemplary embodiments of the present disclosure, the method further comprises: a step S204, transmitting a second message indicating a second RLF over the first path, when the second RLF is detected on the second path. The second message comprises a second RLF report; and the terminal device transmits the second RLF report during the switch.

In exemplary embodiments of the present disclosure, the second RLF report comprises information about at least one of: whether the second RLF happens on a PC5 link, or a Uu link; after how long of receiving the command the second RLF occurred; an identifier of a second relay device for the second path; an identifier of the second cell in which the second RLF has been detected; and/or for how long the second RLF persisted, when the second path restored during the switch.

In exemplary embodiments of the present disclosure, the second message comprises a second indication, indicating that the second path failed.

In exemplary embodiments of the present disclosure, the second message is transmitted to the first relay device, during the switch, or the second message is transmitted to the first relay device over a PC5 link, when the switch is completed; and the first relay device forward the second indication to the first base station, or the second message is transmitted by the terminal device to the first base station.

In exemplary embodiments of the present disclosure, detecting (S202) the second RLF comprises: a substep S2023, obtaining information about the second RLF from the second relay device, when the second RLF is on a Uu link of the second path; or a substep S2023, detecting the second RLF by the terminal device itself, when the second RLF is on a PC5 link of the second path.

In exemplary embodiments of the present disclosure, the second indication comprises information about at least one of: latest measurements available at the terminal device on frequencies of the second path; a cause for the second RLF; and/or whether the second RLF happened on a PC5 link or a Uu link of the second path.

In exemplary embodiments of the present disclosure, the first relay device broadcasts information about the second RLF received from the terminal device; and/or the first relay device transmits information about the second RLF to the second relay device.

FIG. 2E is a flow chart illustrating additional steps of the method as shown in FIG. 2A.

In exemplary embodiments of the present disclosure, the method 200 may further comprise: a step S207, transmitting to the second relay device, an indication about a start of the switch; and/or a step S208, transmitting to the second relay device, an indication about a finish of the switch.

In exemplary embodiments of the present disclosure, the second relay device starts a timer, when receiving the indication about the start of the switch. The second relay device declares the second RLF, when the timer expires before receiving the indication about the finish of the switch.

FIG. 2F is a flow chart illustrating additional steps of the method as shown in FIG. 2A.

In exemplary embodiments of the present disclosure, the method 200 may further comprise: a step S209, triggering a radio resource control, RRC, reestablishment procedure, when the terminal device detects the first RLF and the second RLF.

According to embodiments of the present disclosure, when both paths failed, the terminal device may directly start a RRC reestablishment procedure, to restore the connection to the network.

In exemplary embodiments of the present disclosure, the first RLF and/or the second RLF is detected when at least one of following happens: a physical layer problem over a Uu link or a PC5 link; a random access failure over a Uu link; a radio link control, RLC, failure over a Uu link or a PC5 link; a hybrid automatic repeat request, HARQ, failure over a Uu link or a PC5 link; a listen before talk, LBT, failure over a Uu link or a PC5 link; a beam failure recovery procedure has failed over a Uu link or a PC5 link; a reconfiguration with sync failure over a Uu link or a PC5 link; and/or an expiration of a timer that is started when the switch is started.

In exemplary embodiments of the present disclosure, the method further comprises: a step S210, abandoning the switch and continuing to use the first path for transmissions and receptions, after detecting the second RLF. For example, the second path may be abandoned and/or released, since the RLF occurred. Further, in some situation, the terminal device may try to wait for the recovery of the second path.

In exemplary embodiments of the present disclosure, the terminal device receives a reconfiguration from the first base station, after detecting the second RLF; and the reconfiguration indicates another switch to a third cell, or indicates another second path to the second cell, or indicates a restoration of the first path.

In exemplary embodiments of the present disclosure, the reconfiguration is transmitted within a RRC message, or a downlink message over a downlink control channel, DCCH.

In exemplary embodiments of the present disclosure, the terminal device receives a RRC release message from the first base station, after detecting the first RLF and/or the second RLF.

In exemplary embodiments of the present disclosure, the command indicates a plurality of second paths for the switch, and/or a priority order for the plurality of second paths.

In exemplary embodiments of the present disclosure, the first cell is a new radio, NR, cell, or a long term evolution, LTE, cell; and/or the second cell is a NR cell, or a LTE cell.

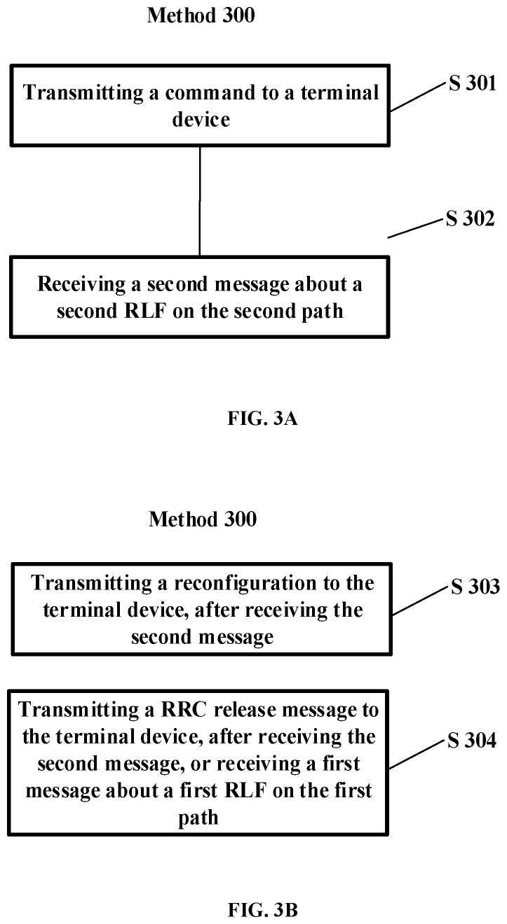

FIG. 3A is a flow chart illustrating a method performed by a first base station, in accordance with some embodiments of the present disclosure.

As shown in FIG. 3A, a second aspect of the present disclosure provides a method 300 performed by a first base station. The method 300 comprises: a step S301, transmitting a command to a terminal device. The command indicates a switch of the terminal device between a first cell and a second cell, and indicates the terminal device to keep a first path with the first cell and a second path with the second cell during the switch. The method 300 further comprises: a step S302, receiving a second message about a second RLF on the second path.

In exemplary embodiments of the present disclosure, the first path is a direct path, or an indirect path via a first relay device. The second path is a direct path, or an indirect path via a second relay device. The first cell is served by the first base station. The second cell is served by a second base station.

In exemplary embodiments of the present disclosure, the first relay device informs the first base station about a first RLF on the first path, when the first relay device detects that the first RLF is on a PC5 link of the first path. The first base station informs the second base station about the switch of the terminal device.

FIG. 3B is a flow chart illustrating additional steps of the method as shown in FIG. 3A.

In exemplary embodiments of the present disclosure, the method 300 further comprises: a step S303, transmitting a reconfiguration to the terminal device, after receiving the second message. The reconfiguration indicates another switch to a third cell, or indicates another second path to the second cell, or indicates a restoration of the first path.

In exemplary embodiments of the present disclosure, the reconfiguration is transmitted within a RRC message, or a downlink message over a downlink control channel, DCCH.

In exemplary embodiments of the present disclosure, the method 300 further comprises: a step S304, transmitting a RRC release message to the terminal device, after receiving the second message, or receiving a first message about a first RLF on the first path.

In exemplary embodiments of the present disclosure, the command indicates a plurality of second paths for the switch, and/or a priority order for the plurality of second paths.

In exemplary embodiments of the present disclosure, the first cell is a new radio, NR, cell, or a long term evolution, LTE, cell. The second cell is a NR cell, or a LTE cell.

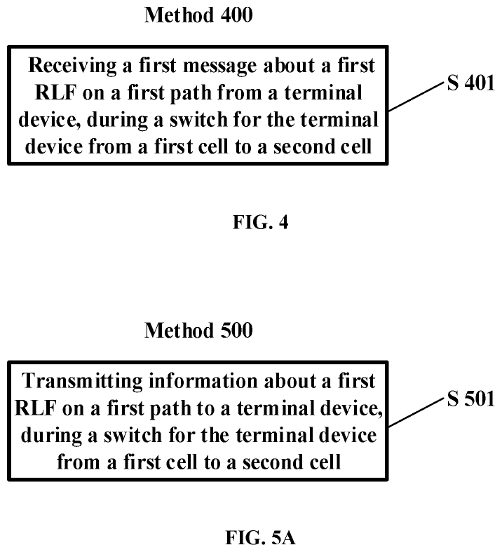

FIG. 4 is a flow chart illustrating a method performed by a second base station, in accordance with some embodiments of the present disclosure.

As shown in FIG. 4, a third aspect of the present disclosure provides a method 400 performed by a second base station. The method 400 comprises: a step S401, receiving a first message about a first RLF on a first path from a terminal device, during a switch for the terminal device between a first cell and a second cell. The terminal device keeps the first path with the first cell and a second path with the second cell during the switch.

In exemplary embodiments of the present disclosure, the first path is a direct path, or an indirect path via a first relay device. The second path is a direct path, or an indirect path via a second relay device. The first cell is served by a first base station. The second cell is served by the second base station.

In exemplary embodiments of the present disclosure, the terminal device informs the first relay device about the switch, after obtaining information about the first RLF from the first relay device, when the first RLF is on a Uu link of the first path. The first relay device informs a third base station about the switch of the terminal device, after reestablishing a connection to the third base station. The third base station informs the second base station about the switch of the terminal device. The third base station is the same as the first base station, or different with the first base station.

In exemplary embodiments of the present disclosure, the first relay device informs the first base station about the first RLF, when the first relay device detects that the first RLF is on a PC5 link of the first path. The first base station informs the second base station about the switch of the terminal device.

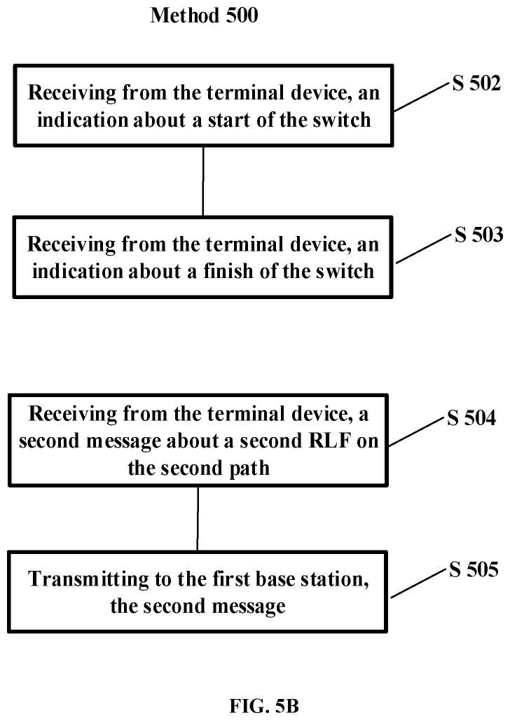

FIG. 5A is a flow chart illustrating a method performed by a second base station, in accordance with some embodiments of the present disclosure.

As shown in FIG. 5A, a fourth aspect of the present disclosure provides a method 500 performed by a first relay device, comprising: a step S501, transmitting information about a first RLF on a first path to a terminal device, during a switch for the terminal device between a first cell and a second cell. The terminal device keeps the first path with the first cell and a second path with the second cell during the switch.

In exemplary embodiments of the present disclosure, the first path is a direct path, or an indirect path via the first relay device. The second path is a direct path, or an indirect path via a second relay device. The first cell is served by a first base station. The second cell is served by a second base station.

In exemplary embodiments of the present disclosure, the terminal device informs the first relay device about the switch, after obtaining information about the first RLF from the first relay device, when the first RLF is on a Uu link of the first path. The first relay device informs a third base station about the switch of the terminal device, after reestablishing a connection to the third base station. The third base station informs the second base station about the switch of the terminal device. The third base station is the same as the first base station, or different with the first base station.

In exemplary embodiments of the present disclosure, the first relay device informs the first base station about the first RLF, when the first relay device detects that the first RLF is on a PC5 link of the first path. The first base station informs the second base station about the switch of the terminal device.

In exemplary embodiments of the present disclosure, the second relay device broadcasts information about the first RLF received from the terminal device. The second relay device transmits information about the first RLF to the first relay device.

FIG. 5B is a flow chart illustrating additional steps of the method as shown in FIG. 5A.

In exemplary embodiments of the present disclosure, the method 500 further comprises: a step S502, receiving from the terminal device, an indication about a start of the switch; and/or step S503, receiving from the terminal device, an indication about a finish of the switch.

In exemplary embodiments of the present disclosure, the first relay device starts a timer, when receiving the indication about the start of the switch. The first relay device declares the first RLF, when the timer expires before receiving the indication about the finish of the switch.

In exemplary embodiments of the present disclosure, the method 500 further comprises: a step S504, receiving from the terminal device, a second message about a second RLF on the second path; and a step S505, transmitting to the first base station, the second message.

In exemplary embodiments of the present disclosure, the first relay device broadcasts information about the second RLF received from the terminal device. The first relay device transmits information about the second RLF to the second relay device.

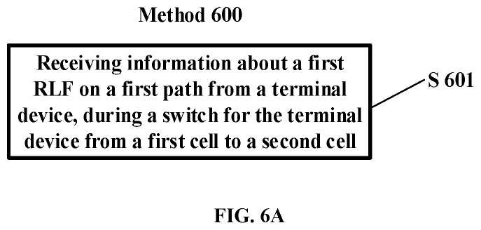

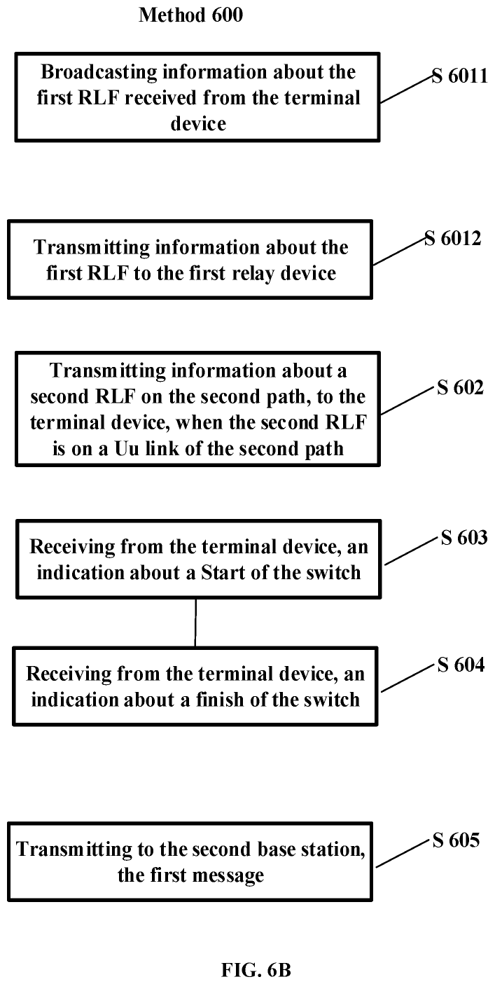

FIG. 6A is a flow chart illustrating a method performed by a second relay device, in accordance with some embodiments of the present disclosure.

As shown in FIG. 6A, a fifth aspect of the present disclosure provides a method 600 performed by a second relay device, comprising: a step S601, receiving information about a first RLF on a first path from a terminal device, during a switch for the terminal device between a first cell and a second cell. The terminal device keeps the first path with the first cell and a second path with the second cell during the switch.

In exemplary embodiments of the present disclosure, the first path is a direct path, or an indirect path via a first relay device. The second path is a direct path, or an indirect path via the second relay device. The first cell is served by a first base station. The second cell is served by a second base station.

FIG. 6B is a flow chart illustrating additional steps of the method as shown in FIG. 6A.

In exemplary embodiments of the present disclosure, the method further comprises: a step S6011, broadcasting information about the first RLF received from the terminal device; or a step S6012, transmitting information about the first RLF to the first relay device.

In exemplary embodiments of the present disclosure, the method 600 further comprises: a step S602, transmitting information about a second RLF on the second path, to the terminal device, when the second RLF is on a Uu link of the second path.

In exemplary embodiments of the present disclosure, the method 600 further comprises: a step S603, receiving from the terminal device, an indication about a start of the switch; and/or a step S604, receiving from the terminal device, an indication about a finish of the switch.

In exemplary embodiments of the present disclosure, the second relay device starts a timer, when receiving the indication about the start of the switch. The second relay device declares the second RLF, when the timer expires before receiving the indication about the finish of the switch.

In exemplary embodiments of the present disclosure, the method 600 further comprises: a step S605, transmitting to the second base station, the first message.

In exemplary embodiments of the present disclosure, the second relay device broadcasts information about the first RLF received from the terminal device; and/or the second relay device transmits information about the first RLF to the first relay device.

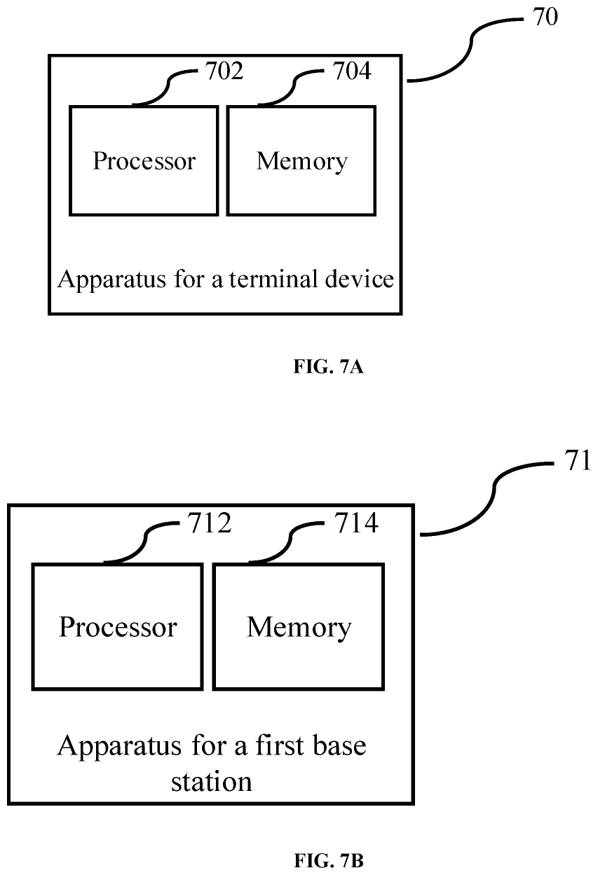

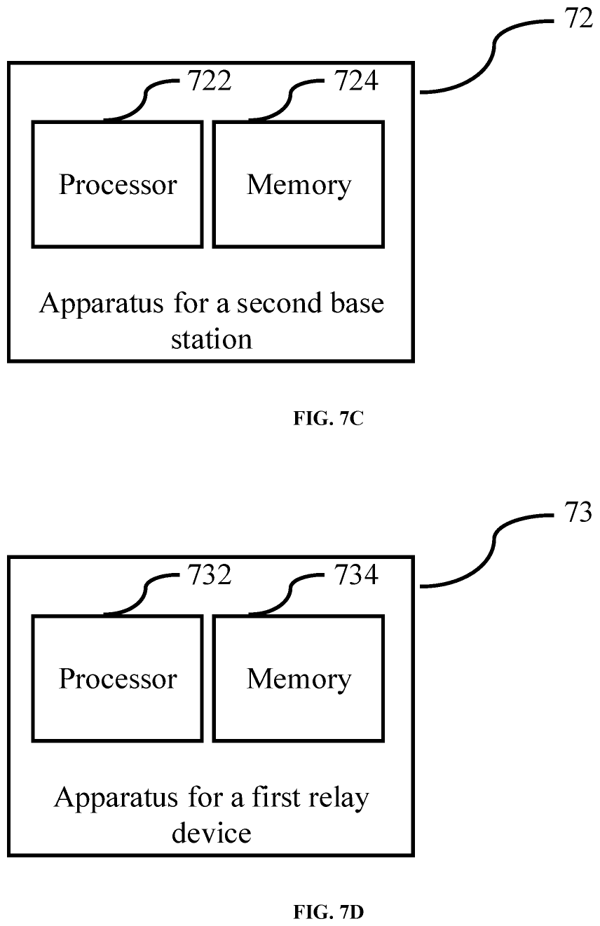

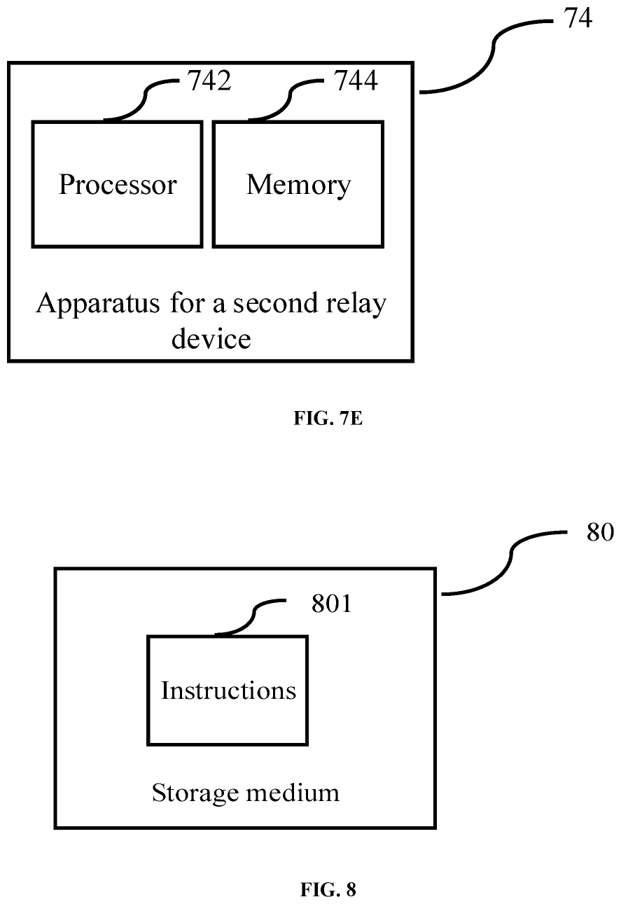

FIG. 7A is a block diagram showing an exemplary apparatus for a terminal device, which is suitable for perform the method according to embodiments of the disclosure.

An apparatus 70 for a terminal device in a communication network comprises: a processor 702, and a memory 704. The memory 704 contains instructions executable by the processor 702. The apparatus 70 for the terminal device is operative for: receiving a command, indicating a switch of the terminal device between a first cell and a second cell, and indicating the terminal device to keep a first path with the first cell and a second path with the second cell during the switch; detecting a radio link failure, RLF, on the first path, and/or on the second path; and transmitting a first message indicating the first RLF over the second path, when the first RLF is detected on the first path.

In exemplary embodiments of the present disclosure, the apparatus is further operative to perform the method according to any of above embodiments, such as shown in FIG. 2A to FIG. 2F.

FIG. 7B is a block diagram showing an exemplary apparatus for a first base station, which is suitable for perform the method according to embodiments of the disclosure.

An apparatus 71 for a first base station in a communication network comprises: a processor 712, and a memory 714. The memory 714 contains instructions executable by the processor 712. The apparatus 71 for the first base station is operative for: transmitting a command to a terminal device. The command indicates a switch of the terminal device between a first cell and a second cell, and indicating the terminal device to keep a first path with the first cell and a second path with the second cell during the switch. The apparatus for the first base station is further operative for: receiving a second message about a second RLF on the second path.

In exemplary embodiments of the present disclosure, the apparatus is further operative to perform the method according to any of above embodiments, such as shown in FIG. 3A to FIG. 3B.

FIG. 7C is a block diagram showing an exemplary apparatus for a second base station, which is suitable for perform the method according to embodiments of the disclosure.

An apparatus 72 for a second base station in a communication network comprises: a processor 722, and a memory 724. The memory 724 contains instructions executable by the processor 722. The apparatus 72 for the second base station is operative for: receiving a first message about a first RLF on a first path from a terminal device, during a switch for the terminal device between a first cell and a second cell. The terminal device keeps the first path with the first cell and a second path with the second cell during the switch.

In exemplary embodiments of the present disclosure, the apparatus is further operative to perform the method according to any of above embodiments, such as shown in FIG. 4.

FIG. 7D is a block diagram showing an exemplary apparatus for a first relay device, which is suitable for perform the method according to embodiments of the disclosure.

An apparatus 73 for a first relay device in a communication network comprises: a processor 732, and a memory 734. The memory 704 contains instructions executable by the processor 732. The apparatus 73 for the first relay device is operative for: transmitting information about a first RLF on a first path to a terminal device, during a switch of the terminal device between a first cell and a second cell. The terminal device keeps the first path with the first cell and a second path with the second cell during the switch.

In exemplary embodiments of the present disclosure, the apparatus is further operative to perform the method according to any of above embodiments, such as shown in FIG. 5A to FIG. 5B.

FIG. 7E is a block diagram showing an exemplary apparatus for a second relay device, which is suitable for perform the method according to embodiments of the disclosure.

An apparatus 74 for a second relay device in a communication network comprises: a processor 742, and a memory 744. The memory 744 contains instructions executable by the processor 742. The apparatus 74 for the second relay device is operative for: receiving information about a first RLF on a first path from a terminal device, during a switch of the terminal device between a first cell and a second cell. The terminal device keeps the first path with the first cell and a second path with the second cell during the switch.

In exemplary embodiments of the present disclosure, the apparatus is further operative to perform the method according to any of above embodiments, such as shown in FIG. 6A to FIG. 6B.

The processors 702, 712, 722, 732, 742 may be any kind of processing component, such as one or more microprocessor or microcontrollers, as well as other digital hardware, which may include digital signal processors (DSPs), special-purpose digital logic, and the like. The memories 704, 714, 724, 734, 744 may be any kind of storage component, such as read-only memory (ROM), random-access memory, cache memory, flash memory devices, optical storage devices, etc.

FIG. 8 is a block diagram showing an apparatus/computer readable storage medium, according to embodiments of the present disclosure.

An eleventh aspect of the present disclosure provides a computer-readable storage medium 80 storing instructions 801, which when executed by at least one processor, cause the at least one processor to perform the method according to any one of above embodiments, such as shown in FIG. 2A to FIG. 6B.

In addition, the present disclosure may also provide a carrier containing the computer program/instructions as mentioned above. The carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

Embodiments herein afford many advantages. According to embodiments of the present disclosure, an improved manner for handling radio link failure during path switch may be provided. Particularly, when the terminal device detects any RLF during a switch, the terminal device does not abort current radio links/paths directly, namely, does not trigger any RRC reestablishment procedure directly. Instead, the terminal device notifies other device (such as relay device, base station, etc.) over the path about the RLF. The switch may be continued in some scenarios, and thus connectivity interruption, extra power consumption and signaling overhead may be avoided or at least mitigated.

FIG. 9A is a block diagram showing units of an exemplary apparatus for a terminal device, which is suitable for perform the method according to embodiments of the disclosure.

An apparatus 90 for a terminal device in a communication network comprises: a receiving unit 902, configured to receive a command, indicating a switch of the terminal device between a first cell and a second cell, and indicating the terminal device to keep a first path with the first cell and a second path with the second cell during the switch; a detecting unit 904, configured to detect a radio link failure, RLF, on the first path, and/or on the second path; and a transmitting unit 906, configured to transmit a first message indicating the first RLF over the second path, when the first RLF is detected on the first path.

In exemplary embodiments of the present disclosure, the apparatus is further operative to perform the method according to any of above embodiments, such as shown in FIG. 2A to FIG. 2F.

FIG. 9B is a block diagram showing units of an exemplary apparatus for a first base station, which is suitable for perform the method according to embodiments of the disclosure.

An apparatus 91 for a first base station in a communication network comprises: a transmitting unit 912, configured to transmit a command to a terminal device. The command indicates a switch of the terminal device between a first cell and a second cell, and indicating the terminal device to keep a first path with the first cell and a second path with the second cell during the switch. The apparatus for the first base station further comprises: a receiving unit 914, configured to receive a second message about a second RLF on the second path.

In exemplary embodiments of the present disclosure, the apparatus is further operative to perform the method according to any of above embodiments, such as shown in FIG. 3A to FIG. 3B.

FIG. 9C is a block diagram showing units of an exemplary apparatus for a base station, which is suitable for perform the method according to embodiments of the disclosure.

An apparatus 92 for a second base station in a communication network comprises: a receiving unit 922, configured to receive a first message about a first RLF on a first path from a terminal device, during a switch for the terminal device between a first cell and a second cell. The terminal device keeps the first path with the first cell and a second path with the second cell during the switch.

In exemplary embodiments of the present disclosure, the apparatus is further operative to perform the method according to any of above embodiments, such as shown in FIG. 4.

FIG. 9D is a block diagram showing units of an exemplary apparatus for a first relay device, which is suitable for perform the method according to embodiments of the disclosure.

An apparatus 93 for a first relay device in a communication network comprises: a transmitting unit 932, configured to transmit information about a first RLF on a first path to a terminal device, during a switch for the terminal device between a first cell and a second cell. The terminal device keeps the first path with the first cell and a second path with the second cell during the switch.

In exemplary embodiments of the present disclosure, the apparatus is further operative to perform the method according to any of above embodiments, such as shown in FIG. 5A to FIG. 5B.

FIG. 9E is a block diagram showing units of an exemplary apparatus for a second relay device, which is suitable for perform the method according to embodiments of the disclosure.

An apparatus 94 for a second relay device in a communication network comprises: a receiving unit 942, configured to receive information about a first RLF on a first path from a terminal device, during a switch for the terminal device between a first cell and a second cell. The terminal device keeps the first path with the first cell and a second path with the second cell during the switch.

In exemplary embodiments of the present disclosure, the apparatus is further operative to perform the method according to any of above embodiments, such as shown in FIG. 6A to FIG. 6B.

The term ‘unit’ may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With these units, the apparatus may not need a fixed processor or memory, any kind of computing resource and storage resource may be arranged from at least one network node/device/entity/apparatus relating to the communication system. The virtualization technology and network computing technology (e.g., cloud computing) may be further introduced, so as to improve the usage efficiency of the network resources and the flexibility of the network.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules/units), or combinations thereof. For a firmware or software, implementation may be made through modules (e.g., procedures, functions, and so on) that perform the functions described herein.

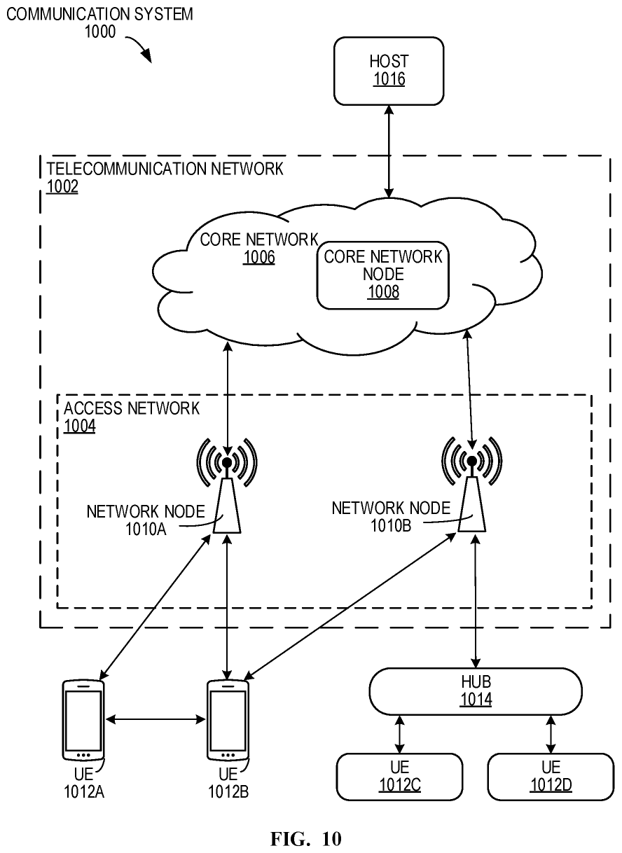

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

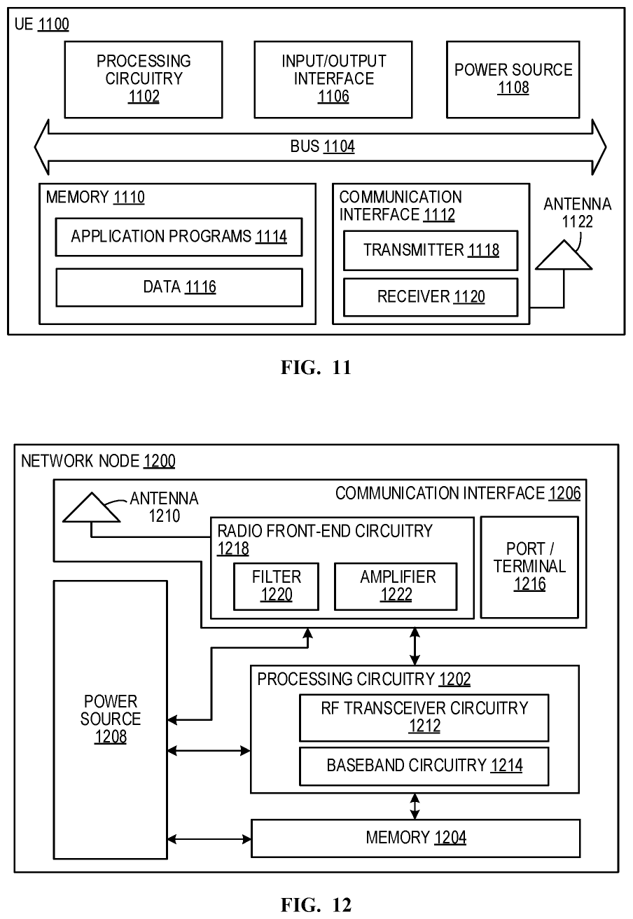

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

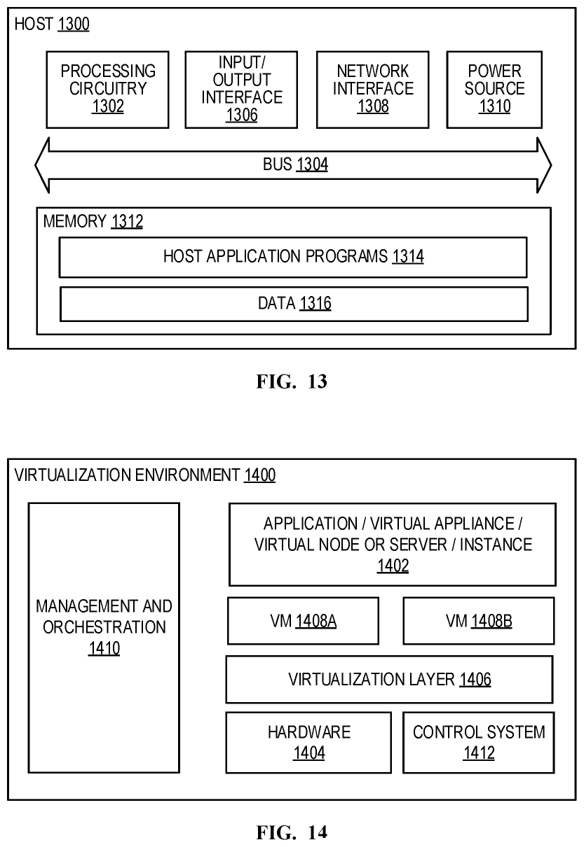

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

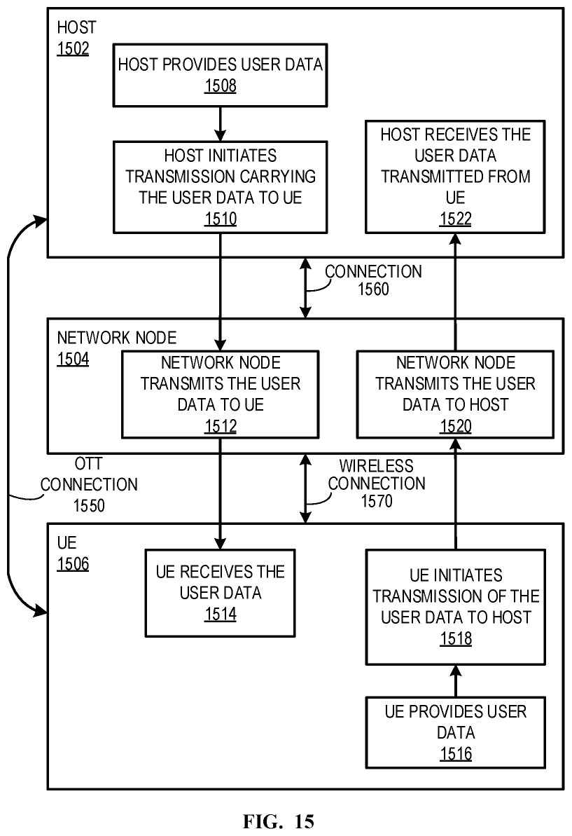

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. According to embodiments of the present disclosure, a manner for handling radio link failure during path switch in communication network may be provided. Particularly, when the terminal device detects any RLF during a switch, the terminal device does not abort current radio links/paths directly, namely, does not trigger any RRC reestablishment procedure directly. Instead, the terminal device notifies other device (such as relay device, base station, etc.) over the path about the RLF. The switch may be continued in some scenarios, and thus connectivity interruption, extra power consumption and signaling overhead may be avoided or at least mitigated. More precisely, the teachings of these embodiments may improve the performance, e.g., data rate, latency, power consumption, of the communication network, and thereby provide benefits such as reduced user waiting time, relaxed restriction on file size, improved content resolution, better responsiveness, extended battery lifetime.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Under the above network circumstances, further detailed embodiments for method and an apparatus for handling radio link failure during path switch may be illustrated below.

Some exemplary embodiments are described in the context of NR, i.e., two or more SL UEs are deployed in a same or different NR cell. However, the same principle may be applied to LTE or any other technology that enables the direct connection of two (or more) nearby devices. The embodiments are also applicable to relay scenarios including UE to network relaying and/or UE to UE relaying where the remote UE and the relay UE may be based on LTE sidelink or NR sidelink, the Uu connection between the relay UE and the base station may be LTE Uu or NR Uu. The embodiments may be applicable to L2 based U2N relaying scenarios.

In the description below, the term direct link/connection refers to a link/connection between a (remote) UE and base station (gNB) over the Uu (NR/LTE) interface. The term indirect link/connection refers to a link/connection between a (remote) UE and base station (gNB) via a relay UE i.e., the connection/link between the (remote) UE and relay UE is over the PC5 interface and that between the relay UE and base station (gNB) is over the Uu interface.

The terms multipath operation/connection with relays and multipath operation/connection are often used inter-changeably. In addition, when referring to a multipath operation with relays/multipath operation, we refer to all the operations possible i.e., utilizing multiple paths simultaneously (for e.g., duplication of packets or data splitting for higher throughput/reliability over multiple paths) or switching among multiple paths. This basically means that a UE keeps two path, link, bearers, or connections active at the same time.

The embodiments are written from the perspective of a (remote) UE (such as, the terminal device), a relay UE (such as, the first relay device, or the second relay device), a source gNB (such as, a first base station), neighboring gNB(s) (such as, the third base station) and a target gNB (such as, the second base station). The (remote) UE is initially under the coverage of a source gNB and subsequently performs a HO (handover)/path switch to a target gNB using multipath relay configurations.

The source/target gNB can consist of multiple cells that the (remote) UE can see. For simplicity, the description below is written such that the (remote) UE performs a HO/path switch from a cell in the source gNB to a cell in the target gNB. As a result, in the description below, cells/gNB(s) are used interchangeably.

The embodiments below are not restricted by any term defined in the above texts. Any other similar term is inter-changeably where applicable here without any loss of the meaning.

The terms “old path/source path” (such as, the first path) are also used to identify the path that the remote UE has with the source gNB, either with a direct Uu link or with a sidelink (source) relay UE (i.e., meaning that the remote UE is connected to the network via the relay UE). At the same time, the terms “new path/target path” (such as, the second path) are used to identify the path that the remote UE has with the target gNB, either with a direct Uu link or with a sidelink (target) relay UE (i.e., meaning that the remote UE is connected to the network via the relay UE).

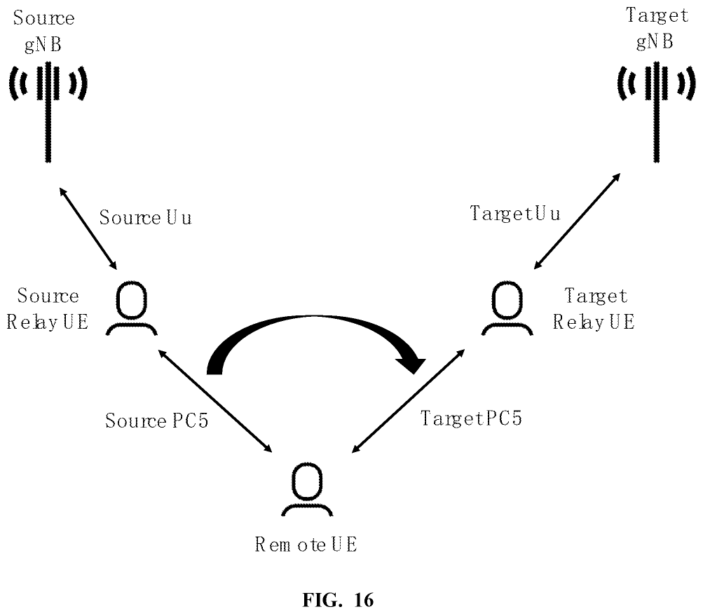

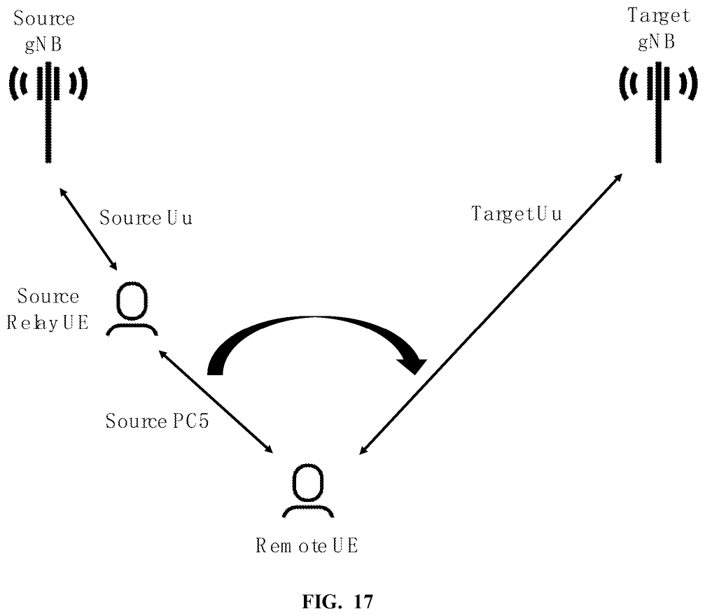

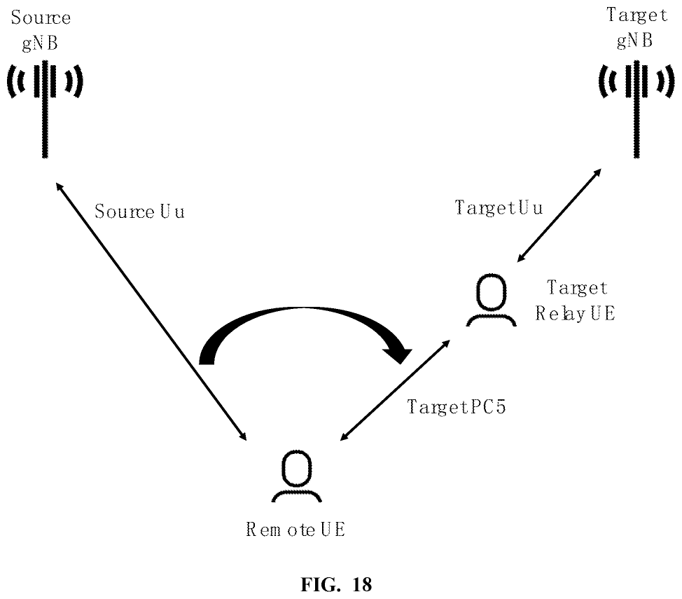

Some exemplary scenarios in this disclosure are depicted in FIG. 16, FIG. 17 and FIG. 18.

FIG. 16 is an exemplary diagram showing a path switch from an indirect to and indirect path in inter-gNBs scenarios.

FIG. 17 is an exemplary diagram showing a path switch from an indirect to a direct path in inter-gNBs scenarios.

FIG. 18 is an exemplary diagram showing a path switch from a direct to an indirect path in inter-gNBs scenarios.

A remote UE is currently connected with the network via an intermediate node, also known as relay UE or via a direct connection. The remote UE perform measurements on frequencies configured by the network and also discover candidate relay UE in proximity. When a stronger cell or a stronger candidate relay UE is found, the remote UE reports these measurements to the network (within a measurement report) and the network decides to hand off the UE to a new target relay UE that belongs to a cell (i.e., a target cell) that is different to the one on which the remote UE is currently connected or to just a new target cell (without any target relay UE). When sending the path switch command to the remote UE, the remote UE is configured to keep both the old path towards the source cell (via the source relay UE) and the new path towards the target cell (and the target relay UE) until the overall path switch procedure is completed.

In one exemplary scenario, the failure may occur over the source path.

In exemplary embodiments of the present disclosure, the remote UE receives a path switch command from the network and at the same time a configuration to keep both the old path towards the source cell (via the source relay UE) and the new path towards the target cell (and the target relay UE) during the path switch. During path switch and upon detecting RLF on the source path, the remote UE generates an RLF report and sends it over the target path when the path switch procedure is completed. In the RLF report, the remote UE collect statistic on the path switch procedure such as:
Whether the source path is a direct path or an indirect path.
Whether the RLF happens on the source PC5, or source Uu in case the source path is an indirect path
After how long of receiving the path switch command the RLF occurred
The ID of the source relay UE (in case the source path is an indirect path) and the ID of the source cell in which the RLF has been detected
For how long (i.e., a time duration) the RLF persisted if the connection went up and running again.

In other exemplary embodiments of the present disclosure, during path switch and upon detecting RLF on the source path, the remote UE sends an indication over the target path that the source path has failed and is not available anymore. This indication can be sent to the target relay UE during the path switch procedure or right after the path switch procedure is completed directly over the target PC5 link and then the target relay UE forward this indication to the target gNB. Yet, in another alternative, the remote UE can send this indication directly to the target gNB (via the target relay UE). In particular, if the RLF over the source path happens on the Uu link of the source relay UE, the remote UE receives an indication that the source Uu link has failed by the source relay UE. Otherwise, if the RLF over the source path happens on the source PC5 link, the remote UE detects itself that the source path has failed.

Yet in other exemplary embodiments of the present disclosure, when the remote UE receives an indication that the Uu link of the source relay UE has failed, it informs the relay UE that it is performing path switching to a certain target gNB, the source relay UE, after reestablishing its RRC connection, informs such info to the (new) gNB which in turn informs the target gNB to which the remote UE(s) is performing path switching. When the relay UE detects that the PC5 link with the remote UE has failed, the relay UE informs the PC5 RLF to its serving gNB, which in turn informs the target gNB to which the remote UE(s) is performing path switching.

In exemplary embodiments of the present disclosure, during path switch and upon detecting RLF on the source path, the remote UE triggers the RRC reestablishment procedure (e.g., cell (re)selection and relay (re)selection) if also an RLF is experienced over the target path (e.g., either on the target Uu link, target PC5 link, or both).

In other exemplary embodiments of the present disclosure, the indication that an RLF over the source path has been detected may include one or more of the following:
whether the source path is a direct path or an indirect path;
the latest measurements available at the remote UE on both Uu and PC5 frequencies;
a failure cause (e.g. t310-expiry, random access problem, etc);
whether the failure happened on the source PC5 link and source Uu link.

In other exemplary embodiments of the present disclosure, RLF during path switch while both source and target path are kept (i.e., on the source or target node) is detected when one (or more) of the following happens:
Detection of physical layer problem (T310 expiry) over Uu or PC5;
Detection of random access problem (random access failure) over Uu;
Indication that the maximum number of RLC retransmission has been reached (RLC failure) over Uu or PC5;
Indication that the maximum number of HARQ NACK/DTX has been reached (HARQ failure) over Uu or PC5;
Indication of consistent LBT failure over Uu or PC5;
Indication that the beam failure recovery procedure has failed over Uu or PC5;
Reconfiguration with sync failure over Uu or PC5;
Upon the expiration of a timer that is started when the path switch is started.

In exemplary embodiments of the present disclosure, the target relay UE, upon receiving an indication from the remote UE that the source path has failed, may broadcast this information to UE in proximity by using sidelink broadcast or sidelink groupcast. Yet, in another alternative, the target relay UE, upon receiving an indication from the remote UE that the source path has failed, it may send a direct message to the source relay UE via sidelink unicast, if the ID of the source relay UE is included in the indication received by the remote UE.

In other exemplary embodiments of the present disclosure, the remote UE indicates the source relay UE that the path switch has started (or is initiated) and send another indication to the source relay UE also when the path switch is finished. When receiving the indication that the path switch is started (or initiated), the source relay UE starts a timer and after the timer expires the RLF over the source path is declared. The timer is stopped when the remote UE sends an indication that the path switch procedure is finished.

In one exemplary scenario, the failure may occur over the target path.

In exemplary embodiments of the present disclosure, the remote UE receives a path switch command from the network and at the same time a configuration to keep both the old path towards the source cell (via the source relay UE) and the new path towards the target cell (and the target relay UE) during the path switch. During path switch and upon detecting RLF on the target path, the remote UE generates an RLF report and sends it over the source path even if the path switch procedure is not completed. In the RLF report, the remote UE collect statistic on the path switch procedure such as:
Whether the RLF happens on the target PC5, or target Uu;
After how long of receiving the path switch command the RLF occurred;
The ID of the target relay UE and the ID of the target cell in which the RLF has been detected;
For how long the RLF persisted if the connection went up and running again.

In other exemplary embodiments of the present disclosure, during path switch and upon detecting RLF on the target path, the remote UE sends an indication over the source path that the target path has failed and is not available anymore. This indication can be sent to the source relay UE during the path switch procedure or right after the path switch procedure is completed directly over the source PC5 link and then the source relay UE forward this indication to the source gNB. Yet, in another alternative, the remote UE can send this indication directly to the source gNB (via the target relay UE). In particular, if the RLF over the target path happens on the Uu link of the target relay UE, the remote UE receives an indication that the target Uu link has failed by the target relay UE. Otherwise, if the RLF over the target path happens on the target PC5 link, the remote UE detects itself that the target path has failed.

In exemplary embodiments of the present disclosure, during path switch and upon detecting RLF on the target path, the remote UE triggers the RRC reestablishment procedure (e.g., cell (re)selection and relay (re)selection) if also an RLF is experienced over the source path (e.g., either on the source Uu link, source PC5 link, or both).

In other exemplary embodiments of the present disclosure, the indication that an RLF over the target path has been detected may include one or more of the following:
the latest measurements available at the remote UE on both Uu and PC5 frequencies;
a failure cause (e.g. t310-expiry, random access problem, etc);
Whether the failure happened on the target PC5 link and target Uu link.

In other exemplary embodiments of the present disclosure, RLF during path switch while both source and target path are kept (i.e., on the source or target node) is detected when one (or more) of the following happens:
Detection of physical layer problem (T310 expiry) over Uu or PC5;
Detection of random access problem (random access failure) over Uu;
Indication that the maximum number of RLC retransmission has been reached (RLC failure) over Uu or PC5;
Indication that the maximum number of HARQ NACK/DTX has been reached (HARQ failure) over Uu or PC5;
Indication of consistent LBT failure over Uu or PC5;
Indication that the beam failure recovery procedure has failed over Uu or PC5;
Reconfiguration with sync failure over Uu or PC5;
Upon the expiration of a timer that is started when the path switch is started.

In exemplary embodiments of the present disclosure, the source relay UE, upon receiving an indication from the remote UE that the target path has failed, may broadcast this information to UE in proximity by using sidelink broadcast or sidelink groupcast. Yet, in another alternative, the source relay UE, upon receiving an indication from the remote UE that the target path has failed, it may send a direct message to the target relay UE via sidelink unicast, if the ID of the target relay UE is included in the indication received by the remote UE.

In other exemplary embodiments of the present disclosure, the remote UE indicates the target relay UE that the path switch has started (or is initiated) and send another indication to the target relay UE also when the path switch is finished. When receiving the indication that the path switch is started (or initiated), the target relay UE starts a timer and after the timer expires the RLF over the target path is declared. The timer is stopped when the remote UE sends an indication that the path switch procedure is finished.

In exemplary embodiments of the present disclosure, during path switch and upon detecting RLF on the target path, the remote UE abort the path switch procedure and continue to use the source path for transmissions and receptions. When doing this, the remote UE can use the previous configuration sent by the source gNB or can ask the source gNB to provide a new one for continuing using the source path.

Further embodiments may also provide solutions for network side (such as the first base station, and/or the second base station) and other common configurations.

In exemplary embodiments of the present disclosure, upon receiving an indication of RLF from the remote UE while performing path switch and while keeping both the source and the target path, the source node generates a new reconfiguration for a new path switch procedure towards a new target path and sends it to the remote UE.

In exemplary embodiments of the present disclosure, a reconfiguration is represented by a new target path (including target gNB and/or target relay UE). Yet, in other exemplary embodiments of the present disclosure, a reconfiguration is represented by configuration so that the connectivity towards the source path can be restored. Further, in other exemplary embodiments of the present disclosure, a reconfiguration is represented by a new target path and a configuration so that the connectivity towards the source path can be restored.

In exemplary embodiments of the present disclosure, the source gNB informs in e.g., the path switching command, multiple new target paths towards the target gNB, where the path may be a direct path or an indirect path, and optionally also indicate the order in which the remote UE shall try to establish connection towards the target gNB, for instance, the remote UE shall first try to establish the connection via the direct path, if that is failed, the remote UE shall then try to establish the connection via a certain indirect path, and so on. If the order is not provided, it is up to the remote UE to select a path from the provided paths to establish the connection to the target gNB.

In exemplary embodiments of the present disclosure, the network indicates in the reconfiguration message whether the remote UE should apply one of the behaviors described in the previous embodiments. Yet, in other exemplary embodiments of the present disclosure, the network does not indicate any behavior the remote UE should follow if the network wants the remote UE to decide autonomously. Further, in exemplary embodiments of the present disclosure, the network does indicate to the remote UE that should decide autonomously which behavior to apply.

In other exemplary embodiments of the present disclosure, the source node sends the reconfiguration to the remote UE within the existing RRCReconfiguration message. Yet, in exemplary embodiments of the present disclosure, the source node sends the reconfiguration to the remote UE within any existing DL message sent over the DCCH channel. Further, in other exemplary embodiments of the present disclosure, the source node sends the reconfiguration to the remote UE within a new RRC message.

In other exemplary embodiments of the present disclosure, upon receiving the RLF indication from the remote UE while performing path switch and while keeping both the source and the target path, the source node generates a RRC release message and sends it to the remote UE.

In exemplary embodiments of the present disclosure, what is described for the source node is the same as for the target node.

According to embodiments of the present disclosure, an improved manner for handling radio link failure during path switch may be provided. Particularly, when the terminal device detects any RLF during a switch, the terminal device does not abort current radio links/paths directly, namely, does not trigger any RRC reestablishment procedure directly. Instead, the terminal device notifies other device (such as relay device, base station, etc.) over the path about the RLF. The switch may be continued in some scenarios, and thus connectivity interruption, extra power consumption and signaling overhead may be avoided or at least mitigated.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

ABBREVIATION EXPLANATION

| | |
|---|---|
| CA | Carrier Aggregation |
| CBR | Channel Busy Ratio |
| CQI | Channel Quality Indicator |
| CSI | Channel State Information |
| DFN | Direct Frame Number |
| DL | Downlink |
| DRX | Discontinuous Reception |
| FDD | Frequency Division Duplex |
| GNSS | Global Navigation Satellite System |
| HARQ | Hybrid automatic repeat request |
| IE | Information Element |
| MAC | Medium Access Control |
| MIB | Master Information Block |
| NSPS | National Security and Public Safety |
| OoC | Out-of-Coverage |
| PDCCH | Physical Downlink Control Channel |
| PDCP | Packet Data Convergence Protocol |
| PDU | Protocol Data Unit |
| PHY | Physical (layer) |
| PL | Path Loss |
| PMI | Precoding Matrix Indicator |
| ProSe | Proximity Services |
| PSCCH | Physical Sidelink Control Channel |
| PSSCH | Physical Sidelink Shared Channel |
| RL | Relay |
| RLC | Radio link control |
| RM | Remote |
| RI | Rank Indicator |
| RRC | Radio Resource Control |
| RSRP | Reference Signal Received Power |
| RSSI | Received Signal Strength Indicator |
| RX | Receive, receiver |
| SFN | System Frame Number |
| SIB | System Information Block |
| SINR | Signal to interference noise ration |
| SL | Sidelink |
| SLRB | Sidelink Radio Bearer |
| SLSS | Sidelink Synchronization Signals |
| SynchUE | Synchronization UE |
| TDD | Time Division Duplex |
| TETRA | Terrestrial Trunked Radio |
| TX | Transmit, transmitter |
| UE | User Equipment |
| UL | Uplink |
| V2V | Vehicle-to-vehicle |
| V2X | Vehicle-to-anything |
| 3GPP TS | Third generation partnership project technical specification |

1. A method performed by a terminal device, comprising:
receiving a command, indicating a switch of the terminal device between a first cell and a second cell, and indicating the terminal device to keep a first path with the first cell and a second path with the second cell during the switch;
detecting a radio link failure, RLF, on the first path and/or on the second path; and
transmitting a first message indicating a first RLF over the second path, when the first RLF is detected on the first path.

2. The method according to claim 1,
wherein the first path is a direct path, or an indirect path via a first relay device;
wherein the second path is a direct path, or an indirect path via a second relay device;
wherein the first cell is served by a first base station;
wherein the second cell is served by a second base station;
wherein the terminal device is a remote user equipment, UE;
wherein the first relay device is a relay UE;
wherein the second relay device is a relay UE;
wherein the first message comprises a first RLF report; and
wherein the terminal device transmits the first RLF report when or after the switch is completed.

3-4. (canceled)

5. The method according to claim 2,
wherein the first RLF report comprises information about at least one of:
whether a first path is a direct path or an indirect path;
whether the first RLF happens on a PC5 link, or a Uu link, when the first path is an indirect path;
after how long of receiving the command the first RLF occurred;
an identifier of a first relay device for the first path, when the first path is an indirect path;
an identifier of the first cell in which the first RLF has been detected; and/or
a time duration the first RLF persisted, when the first path restored from the first RLF during the switch.

6. The method according to claim 2,
wherein the first message comprises a first indication, indicating that the first path failed;
wherein the first message is transmitted to the second relay device, during the switch; or
wherein the first message is transmitted to the second relay device over a PC5 link, when the switch is completed; or
wherein the first message is transmitted by the terminal device to the second base station.

7. (canceled)

8. The method according to claim 6,
wherein detecting the first RLF comprises:
obtaining information about the first RLF from the first relay device, when the first RLF is on a Uu link of the first path; or
detecting the first RLF by the terminal device, when the first RLF is on a PC5 link of the first path;
informing the first relay device about the switch, after obtaining information about the first RLF from the first relay device, when the first RLF is on a Uu link of the first path;
wherein information about the first RLF is transmitted by the first relay device to the first base station, when the first relay device detects that the first RLF is on a PC5 link of the first path; and
wherein the first base station informs the second base station about the switch of the terminal device.

9-10. (canceled)

11. The method according to claim 6,
wherein the first indication comprises information about at least one of:
whether the first path is a direct path or an indirect path;
latest measurements available at the terminal device on frequencies of the first path;
a cause for the first RLF; and/or
whether the first RLF happened on a PC5 link or a Uu link of the first path;
wherein information about the first RLF received from the terminal device is further broadcast by the second relay device; and/or
wherein information about the first RLF is further transmitted by the second relay device to the first relay device.

12. (canceled)

13. The method according to claim 2:
transmitting to the first relay device, an indication about a start of the switch; and/or
transmitting to the first relay device, an indication about a finish of the switch;
wherein the first relay device starts a timer, when receiving the indication about the start of the switch; and
wherein the first relay device declares the first RLF, when the timer expires before receiving the indication about the finish of the switch.

14. (canceled)

15. The method according to claim 2, further comprising:
transmitting a second message indicating a second RLF over the first path, when the second RLF is detected on the second path;
wherein the second message comprises a second RLF report; and
wherein the terminal device transmits the second RLF report during the switch;
wherein the second RLF report comprises information about at least one of:
whether the second RLF happens on a PC5 link, or a Uu link;
after how long of receiving the command the second RLF occurred;
an identifier of a second relay device for the second path;
an identifier of the second cell in which the second RLF has been detected; and/or
for how long the second RLF persisted, when the second path restored during the switch.

16. (canceled)

17. The method according to claim 15,
wherein the second message comprises a second indication, indicating that the second path failed;
wherein the second message is transmitted to the first relay device, during the switch, or the second message is transmitted to the first relay device over a PC5 link, when the switch is completed; and
wherein the first relay device forward the second indication to the first base station, or the second message is transmitted by the terminal device to the first base station.

18. (canceled)

19. The method according to claim 17,
wherein detecting the second RLF comprises:
obtaining information about the second RLF from the second relay device, when the second RLF is on a Uu link of the second path; or
detecting the second RLF by the terminal device itself, when the second RLF is on a PC5 link of the second path;
wherein the second indication comprises information about at least one of:
latest measurements available at the terminal device on frequencies of the second path;
a cause for the second RLF; and/or
whether the second RLF happened on a PC5 link or a Uu link of the second path.

20. (canceled)

21. The method according to claim 17,
wherein the first relay device broadcasts information about the second RLF received from the terminal device; and/or
wherein the first relay device transmits information about the second RLF to the second relay device.

22. The method according to claim 15, further comprising:
transmitting to the second relay device, an indication about a start of the switch; and/or
transmitting to the second relay device, an indication about a finish of the switch;
wherein the second relay device starts a timer, when receiving the indication about the start of the switch;
wherein the second relay device declares the second RLF, when the timer expires before receiving the indication about the finish of the switch.

23. (canceled)

24. The method according to claim 1, further comprising:
triggering a radio resource control, RRC, reestablishment procedure, when the terminal device detects the first RLF and the second RLF.

25. The method according to claim 1,
wherein the first RLF and/or the second RLF is detected when at least one of following happens:
a physical layer problem over a Uu link or a PC5 link;
a random access failure over a Uu link;
a radio link control, RLC, failure over a Uu link or a PC5 link;
a hybrid automatic repeat request, HARQ, failure over a Uu link or a PC5 link;
a listen before talk, LBT, failure over a Uu link or a PC5 link;
a beam failure recovery procedure has failed over a Uu link or a PC5 link;
a reconfiguration with sync failure over a Uu link or a PC5 link; and/or
an expiration of a timer that is started when the switch is started.

26. (canceled)

27. The method according to claim 1,
wherein the terminal device receives a reconfiguration from the first base station, after detecting the second RLF; and
wherein the reconfiguration indicates another switch to a third cell, or indicates another second path to the second cell, or indicates a restoration of the first path; wherein the reconfiguration is transmitted within a RRC message, or a downlink message over a downlink control channel, DCCH;
wherein the terminal device receives a RRC release message from the first base station, after detecting the first RLF and/or the second RLF.

28-31. (canceled)

32. A method performed by a first base station, comprising:
transmitting a command to a terminal device, wherein the command indicates a switch for the terminal device between a first cell and a second cell, and indicates the terminal device to keep a first path with the first cell and a second path with the second cell during the switch; and
receiving a second message about a second RLF on the second path.

33. The method according to claim 32,
wherein the first path is a direct path, or an indirect path via a first relay device; and/or
wherein the second path is a direct path, or an indirect path via a second relay device; and/or
wherein the first cell is served by the first base station; and/or
wherein the second cell is served by a second base station;
wherein the first relay device informs the first base station about a first RLF on the first path, when the first relay device detects that the first RLF is on a PC5 link of the first path; and
wherein the first base station informs the second base station about the switch of the terminal device;
wherein the first relay device informs the first base station about a first RLF on the first path, when the first relay device detects that the first RLF is on a PC5 link of the first path; and
wherein the first base station informs the second base station about the switch of the terminal device.

34. (canceled)

35. The method according to claim 32, further comprising:
transmitting a reconfiguration to the terminal device, after receiving the second message;
wherein the reconfiguration indicates another switch to a third cell, or indicates another second path to the second cell, or indicates a restoration of the first path; wherein the reconfiguration is transmitted within a RRC message, or a downlink message over a downlink control channel, DCCH.

36. (canceled)

37. The method according to claim 32, further comprising:
transmitting a RRC release message to the terminal device, after receiving the second message, or receiving a first message about a first RLF on the first path.

38-64. (canceled)

65. An apparatus for a second base station, comprising:
a processor; and
a memory, the memory containing instructions executable by the processor, whereby the apparatus for the second base station is operative for:
receiving a first message about a first RLF on a first path from a terminal device, during a switch for the terminal device between a first cell and a second cell;
wherein the terminal device keeps the first path with the first cell and a second path with the second cell during the switch.

66-71. (canceled)
